(19) United States
(12) Patent Application Publication
(10) Pub. No.: US 2010/0114618 A1
(43) Pub. Date: May 6, 2010

(54) Management of Variants of Model of Service

(75) Inventors: Lawrence Wilcock, Malmesbury Wiltshire (GB); Nigel Edwards, Bristol (GB); Guillaume Alexandre Belrose, Marlborough (GB); Johannes Kirschnick, Bristol (GB); Jerome Rolia, Kanata Ontario (CA)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Packard Development Company, L.P., Houston, TX (US)

(21) Appl. No.: 12/261,355

(22) Filed: Oct. 30, 2008

(51) Int. Cl. G06Q 10/00

(52) U.S. Cl. 705/7

(57) ABSTRACT

A system for developing a computer implemented service, for deployment on computing infrastructure, generates variants of the model by automatically choosing values for a limited set of design variables, and evaluates the variants in operation. A model manager (187) stores in a model repository (107) a current variant (57) and at least some previous variants, and their evaluation results and derivation trails, the generating part being arranged to use the evaluation results and the derivation trails to generate a next current variant. Such use of the repository can help make more efficient the search by the model manager for variants that work well. In particular the derivation trails and evaluations can make it easier to determine when to revert to a preceding variant or determine what new design choices to try next.

### RELATED APPLICATIONS

This application relates to copending US applications of even date titled “AUTOMATED LIFECYCLE MANAGEMENT OF A COMPUTER IMPLEMENTED SERVICE”, (applicant reference number 200801918), and titled “CHANGE MANAGEMENT OF MODEL OF SERVICE” (applicant reference number 2008019219), and to previously filed US applications titled “INCORPORATING DEVELOPMENT TOOLS IN SYSTEM FOR DEPLOYING COMPUTER BASED PROCESS ON SHARED INFRASTRUCTURE” (applicant reference number 20072601), titled “MODEL BASED DEPLOYMENT OF COMPUTER BASED BUSINESS PROCESS ON DEDICATED HARDWARE” (applicant reference number 200702144), titled “VISUAL INTERFACE FOR SYSTEM FOR DEPLOYING COMPUTER BASED PROCESS ON SHARED INFRASTRUCTURE” (applicant reference number 200702356), titled “MODELLING COMPUTER BASED BUSINESS PROCESS FOR CUSTOMISATION AND DELIVERY” (applicant reference number 200702363), titled “MODELLING COMPUTER BASED BUSINESS PROCESS AND SIMULATING OPERATION” (applicant reference number 200702377), titled “AUTOMATED MODEL GENERATION FOR COMPUTER BASED BUSINESS PROCESS”, (applicant reference number 200702600), and titled “SETTING UP DEVELOPMENT ENVIRONMENT FOR COMPUTER BASED BUSINESS PROCESS”, (applicant reference number 200702145), and previously filed US application titled “DERIVING GROUNDED MODEL OF BUSINESS PROCESS SUITABLE FOR AUTOMATIC DEPLOYMENT” (Ser. No. 11/741878) all of which are hereby incorporated by reference in their entirety.

### FIELD OF THE INVENTION

The invention relates to systems for developing a computer implemented service, for deployment on computing infrastructure, methods of providing such a service, methods of providing shared infrastructure for such a system and service, and to corresponding software.

### BACKGROUND

Physical IT (information technology) infrastructures are difficult to manage. Changing the network configuration, adding a new machine or storage device are typically difficult manual tasks. This makes such changes expensive and error prone. It also means that the change can take several hours or days to take place, limiting the rate at which reconfiguration can take place to take account of changing business demands. Sometimes the reconfiguration can take months, as more equipment needs to be ordered before it can be implemented.

A physical IT infrastructure can have only one configuration at any one time. Although this configuration might be suitable for some tasks, it is typically sub-optimal for other tasks. For example, an infrastructure designed for running desktop office applications during the day may not be suitable for running complicated numerical analysis applications during the night. In a single physical IT infrastructure, separate tasks can interfere with each other. For example, it has been proposed to use spare compute cycles on desktops and servers to perform large scale computations: grid applications. One problem is how to isolate the network traffic, the data storage and processing of these computations from other tasks using the same infrastructure. Without isolation undesirable interference between the tasks is likely to occur rendering such sharing an unacceptable risk.

In most physical IT infrastructure, resource utilization is very low: 15% is not an uncommon utilization for a server, 5% for a desktop. This means that customers have purchased far more IT infrastructure than they need. HP's UDC (Utility Data Centre) has been applied commercially and addresses some of these problems, by automatic reconfiguration of physical infrastructure: processing machines, network and storage devices. This requires specialized hardware which makes it expensive. In addition in the UDC a physical machine can only ever be in a single physical infrastructure. This means that all programs running on that physical machine will be exposed to the same networking and storage environment: they can interfere with each other and the configuration may not be optimal for all programs. In UDC although a physical machine can be reassigned to different infrastructure instances, called farms, at different times, it can only be assigned to one farm, at any given moment: it is not possible to share a physical machine between farms. This limits the utilization that levels that can be achieved for the hardware, requiring the customer to purchase more hardware than is necessary.

Parts of the IT infrastructure can be offered as a service. Servers, storage, and networking can be offered by internal corporate IT providers or Internet service providers. Email, word processing, and other simple business applications are now offered by many providers. Other services can be more complex business applications that implement business processes such as customer relationship management, order and invoice processing, and supply chain management are also offered as a service for example and many others can be envisaged including online gaming, online retailing and so on. In principle any software can be offered as a service. Other examples include rendering of computer animation for movies, web applications, computer simulations of physical systems, and financial modelling. A service can be offered in several ways. It can be a portal that is accessed via Web browsers, a Web service endpoint, or a combination of the two and can be provided over the internet, or intranets, using wired or wireless networks for example. In some cases services can implement business processes for small business or larger enterprise class customers. These customers may have thousands or more employees and thousands or millions of users or Web enabled devices that interact with their service. There are several actors that can participate in Software as a service (SaaS). Infrastructure providers provide the (typically shared) infrastructure, physical and virtual, for the operation of service instances. Service providers provide software that is packaged as a service. These service providers may be customers of the infrastructure providers. Software vendors create such software. End customers contract with an infrastructure provider or software provider to consume a service. A service implements business processes for customers. A Service instance provides the service to a customer. A service provider may have development, testing, and production instances of a service. The users of the service are employees, IT systems, Web enabled devices, or business partners of the customer. In some cases, the infrastructure provider, software provider, and software vendor are one entity.

Model-driven techniques have been considered by many researchers and exploited in real world environments. In general, the techniques capture information in models that can be used to automatically generate code, configuration information, or changes to configuration information. The goal of model-driven approaches is to increase automation and reduce the human effort and costs needed to support IT systems. Systems can have many aspect-specific viewpoints, e.g., functionality, security, performance, conformance, each with a model. The concept of viewpoints was introduced in the ODP Reference Model for Distributed Computing.

There are several different paradigms for how service instances can be rendered into shared resource pools. These can be classified as multi-tenancy, isolated-tenancy, and hybrid-tenancy. Multi-tenancy hosts many customers with one instance of a software service. Isolated-tenancy creates a separate service instance for each customer. A hybrid may share some portion of a service instance such as a database across many customers while maintaining isolated application servers. Multi-tenancy systems can reduce maintenance and management challenges for providers, but it can be more difficult to ensure customer specific service levels. Isolated-tenancy systems provide for greatest performance flexibility and greatest security, but present greater maintenance challenges. Hybrid-tenancy approaches have features of both approaches.

Rendering service instances into shared virtualized resource pools presents configuration, deployment and management challenges, and various approaches are known. The lifecycle of a service can include any or all of for example initial specification, through design, to deployment and eventual decommissioning. Each potential customer may have specific requirements for the service, both functional and non-functional. Services do not conform to a one size fits all approach. A service provider must be able offer multiple variants of a service, whose behaviour and design are targeted to the customer requirements. Service design is the process of creating not only an optimised hardware and software configuration, but also a specification of the appropriate service lifecycle behaviour that matches that configuration. The lifecycle behaviour such as how to adapt the service in response to given changes in environment or changes to requirements, is typically fixed at the outset.

A known example of model-based automation is Eilam et al. (“Model-Based Automation of Service Deployment in a Constrained Environment,” T. Eilam et al., Tech. rep. RC23382, IBM, September 2004. and “Reducing the Complexity of Application Deployment in Large Data Centers,” T. Eilam et al., IFIP/IEEE Int'l. Symp. on Integrated Mgmt., 2005.), who describe a system that matches distributed application network topologies to the infrastructure network topology that is available in the data centre. They use transformations on application topology models to transform the topology into something that matches what can be deployed using the data centre's infrastructure.

### SUMMARY OF THE INVENTION

An object is to provide improved apparatus or methods. In one aspect the invention provides a system for developing a computer implemented service, for deployment on computing infrastructure, the system having a model manager arranged to develop a model representing at least part of the service, and representing at least part of the computing infrastructure for the service, the model manager having:

a generating part arranged to generate variants of the model by automatically choosing values for a limited set of design variables, and an evaluating part for evaluating the variants in operation, the model manager being arranged to store in a model repository a current variant and at least some previous variants, and their evaluation results and derivation trails indicating how the variants are derived from each other, the generating part being arranged to use the evaluation results and the derivation trails to generate a next current variant by making new choices of values, or by reverting to one of the previous variants.

Other aspects encompass parts of the system such as some of the software for the system and methods of using the system. The methods are intended to encompass cases where the system is partly or largely located outside the jurisdiction, yet the user is using the system and gaining the benefit, from within the jurisdiction. These and other aspects can encompass human operators using the system, to enable direct infringement or inducing of direct infringement in cases where the infringers system is partly or largely located remotely and outside the jurisdiction covered by the patent, as is feasible with many such systems, yet the human operator is using the system and gaining the benefit, from within the jurisdiction. Other advantages will be apparent to those skilled in the art, particularly over other prior art. Any of the additional features can be combined together, and combined with any of the aspects, as would be apparent to those skilled in the art. The embodiments are examples only, the scope is not limited by these examples, and many other examples can be conceived within the scope of the claims.

### BRIEF DESCRIPTION OF THE FIGURES

Specific embodiments of the invention will now be described, by way of example, with reference to the accompanying figures, in which:

FIG. 1 shows a schematic view of a system according to an embodiment

FIG. 2 shows steps according to another embodiment,

FIG. 3 shows another embodiment having evaluation in parallel,

FIG. 4 shows another embodiment having evaluation and generation of variants,

FIG. 5 shows another embodiment showing deployment of a clone,

FIGS. 6 and 7 show a schematic view of a structure of derivation trails of variants during different development stages according to an embodiment,

FIG. 8 shows a schematic view of a sequence of states in the lifecycle of the service model,

FIG. 9 shows a schematic view of examples of change requests representing a sequence of operators for changing the service model,

FIG. 10 shows a view of a sequence of development states of the service model according to an embodiment,

FIG. 11 shows a view of the sequence of FIG. 10 and showing types of transitions between the states,

FIG. 12 shows a view of state transitions in a transition model, being accessed by a service model state manager in the form of a model lifecycle service and change request engine,

FIG. 13 shows a schematic view of a model lifecycle service carrying out validity checks on representations of state transitions in the transition model,

FIG. 14 shows another embodiment having two stages of templates, an infrastructure design template and a system template,

FIG. 15 shows an example of a system template model in the form of a UML diagram for part of a decentralized SAP system, and

FIG. 16 shows an example of a design of a service in the form of a custom model of a business method known as a Sales and Distribution (SD) Benchmark produced by the company SAP, suitable for use with the STM of FIG. 15.

### DESCRIPTION OF SPECIFIC EMBODIMENTS

Definitions:

“allowed operations” can encompass any type of operation to cause changes to any part of a model, and can be allowed in the sense that an operation can be invoked, or that other checks on the operation are made and passed. Examples include checking parameters or default values for parameters are allowed, ranges or conditions on parameters are allowed, or that dependencies on other operations having been first carried out are fulfilled. It can encompass operations which are always allowed, or operations which are allowed under some circumstances, for example allowed for some users but not others. Operations can be allowed for a given entity in the model, or allowed for many entities, and can be allowed under given conditions.

“model” is intended to encompass any kind of representation of a design and can encompass data structures, or code or combinations of these, for example, and can be made up of sub models located at different locations for example.

“rendering tool” is intended to encompass software tools or any other mechanism for carrying out a desired function.

“change manager” is intended to encompass any kind of software, service, tool or process or combination of these, for managing the change, or causing it to be carried out. It can encompass software tools or any other mechanism for the execution of allowed operations according to the constraints defined by those allowed operations. The change manager may make use of tools to carry out the operations.

“Evaluating” or “evaluation” of variants is intended to encompass any kind of evaluation, including analytical evaluation, simulation of operation with simulated inputs, or evaluating outputs of a deployed instance, and comparing the outputs or results to any kind of standard or requirements, or making comparisons to outputs of other variants.

“model repository” is intended to encompass any kind of storage for models, regardless of location or how it is divided or spread over different locations, or whether it is virtualised.

“automatically” is intended to cover completely autonomous action by software, or partial automation which involves proposing one or more actions and obtaining some input by a human operator, to make selections or authorisations for example.

“lifecycle” is defined as encompassing some or all stages of development of a service such as requirements collection, design, deployment, testing and run time management. Deployment is the process of instantiating and reifying a design of a service so that it can be made available to users.

“derivation trails” can encompass any kind of indication of how a variant has been or can be derived from another variant or variants. This can comprise a self contained definition of how to rebuild a given variant, or can include references to other sources.

“lifecycle management” can encompass management of part or all of the lifecycle.

“user” of a service can encompass a human user or another service.

“requirements” can include functional and non-functional requirements for a given service, and can alter during the lifecycle.

“Functional requirements” can encompass what the service is intended to do, such as the business processes offered or other behaviours or functionality.

“operators” encompasses functions for invoking tools. Tools can perform analysis, modify the TM or SM, or collect requirements for example.

“automated inspection”, and “automated adaptation” can encompass fully automated or partially automated actions, where partially automated encompasses having human input.

“parameters” for the operators encompasses parameters passed by the operators to the tools they invoke. Parameters can encompass any type of information that can modify the behaviour of the operation.

“execution constraints” can encompass for example preconditions on whether the operation is currently allowed (such as time of day restrictions), or restrictions on values of parameters used (such as ranges or combinations of values), and whether operations can or must occur in parallel or sequentially, and so on.

“non-functional requirements” can encompass how well the functional steps are achieved, in terms such as performance, security properties, cost, availability and others. It is explained in Wikipedia (http://en.wikipedia.org/wiki/Non-functional_requirements) for non-functional requirements as follows—“In systems engineering and requirements engineering, non-functional requirements are requirements which specify criteria that can be used to judge the operation of a system, rather than specific behaviors. This should be contrasted with functional requirements that specify specific behavior or functions. Typical non-functional requirements are reliability, scalability, and cost. Non-functional requirements are often called the ilities of a system. Other terms for non-functional requirements are “constraints”, “quality attributes” and “quality of service requirements”.”

Functional steps can encompass any type of function of the business process, for any purpose, such as interacting with an operator receiving inputs, retrieving stored data, processing data, passing data or commands to other entities, and so on, typically but not necessarily, expressed in human readable form . . . .

“Deployed” is intended to encompass a modelled business process for which the computing infrastructure has been allocated and configured, and the software application components have been installed and configured ready to become operational. According to the context it can also encompass a business process which has started running.

“suitable for automated deployment” can encompass models which provide machine readable information to enable the infrastructure design to be deployed, and to enable the software application components to be installed and configured by a deployment service, either autonomously or with some human input guided by the deployment service.

“business process” is intended to encompass any process involving computer implemented steps and optionally other steps such as human input or input from a sensor or monitor for example, for any type of business purpose such as service oriented applications, for sales and distribution, inventory control, control or scheduling of manufacturing processes for example. It can also encompass any other process involving computer implemented steps for non business applications such as educational tools, entertainment applications, scientific applications, any type of information processing including batch processing, grid computing, and so on. One or more business process steps can be combined in sequences, loops, recursions and branches to form a complete Business Process. Business process can also encompass business administration processes such as CRM, sales support, inventory management, budgeting, production scheduling and so on, and any other process for commercial or scientific purposes such as modelling climate, modelling structures, or modelling nuclear reactions.

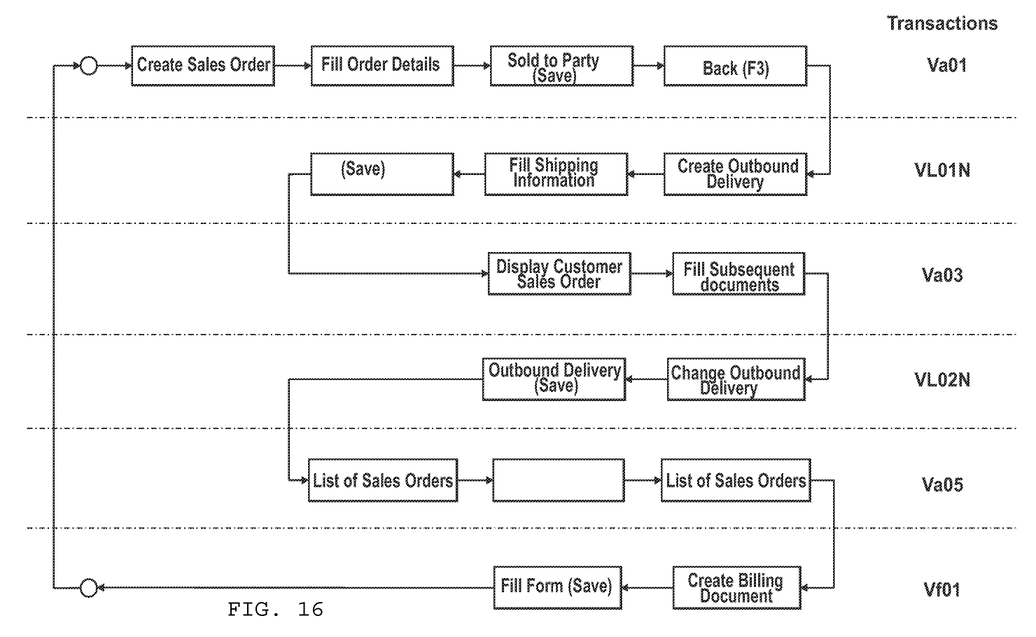

“application components” is intended to encompass any type of software element such as modules, subroutines, code of any amount usable individually or in combinations to implement the computer implemented steps of the business process. It can be data or code that can be manipulated to deliver a business process step (BPStep) such as a transaction or a database table. The Sales and Distribution (SD) product produced by SAP, and described below with reference to FIG. 16 is made up of a number of transactions each having a number of application components for example.

“unbound model” is intended to encompass software specifying in any way, directly or indirectly, at least the application components to be used for each of the computer implemented steps of the business process, without a complete design of the computing infrastructure, and may optionally be used to calculate infrastructure resource demands of the business process, and may optionally be spread across or contain two or more sub-models. The unbound model can also specify the types or versions of corresponding execution components such as application servers and database servers, needed by each application component, without specifying how many of these are needed for example.

“grounded model” is intended to encompass software specifying in any way, directly or indirectly, at least a complete design of the computing infrastructure suitable for automatic deployment of the business process. It can be a complete specification of a computing infrastructure and the application components to be deployed on the infrastructure.

“bound model” encompasses any model having a binding of the Grounded Model to physical resources. The binding can be in the form of associations between ComputerSystems, Disks, StorageSystems, Networks, NICS that are in the Grounded Model to real physical parts that are available in the actual computing infrastructure. “infrastructure design template” is intended to encompass software of any type which determines design choices by indicating in any way at least some parts of the computing infrastructure, and indicating predetermined relationships between the parts. This will leave a limited number of options to be completed, to create a grounded model. These templates can indicate an allowed range of choices or an allowed range of changes for example. They can determine design choices by having instructions for how to create the grounded model, or how to change an existing grounded model.

“computing infrastructure” is intended to encompass any type of resource such as hardware and software for processing, for storage such as disks or chip memory, and for communications such as networking, and including for example servers, operating systems, virtual entities, and management infrastructure such as monitors, for monitoring hardware, software and applications. All of these can be “designed” in the sense of configuring and/or allocating resources such as processing time or processor hardware configuration or operating system configuration or disk space, and instantiating software or links between the various resources for example. The resources may or may not be shared between multiple business processes. The configuring or allocating of resources can also encompass changing existing configurations or allocations of resources. Computing infrastructure can encompass all physical entities or all virtualized entities, or a mixture of virtualized entities, physical entities for hosting the virtualized entities and physical entities for running the software application components without a virtualized layer.

“parts of the computing infrastructure” is intended to encompass parts such as servers, disks, networking hardware and software for example.

“server” can mean a hardware processor for running application software such as services available to external clients, or a software element forming a virtual server able to be hosted by a hosting entity such as another server, and ultimately hosted by a hardware processor.

“AIService” is an information service that users consume. It implements a business process.

“ApplicationExecutionComponent” is for example a (worker) process, thread or servlet that executes an Application component. An example would be a Dialog Work Process, as provided by SAP.

“ApplicationExecutionService” means a service which can manage the execution of ApplicationExecutionComponents such as Work Processes, servlets or data-base processes. An example would be an Application Server as provided by SAP. Such an application server includes the collection of dialog work processes and other processes such as update and enqueue processes.

“Application Performance Model” means any model which has the purpose of defining the resource demands, direct and indirect, for each Business process (BP) step. It could be used by an Application Performance Engine, and can be contained in the unbound model.

“Component Performance Model” can mean any model containing the generic performance characteristics for an Application Component. This can be used to derive the Application Performance Model (which can be contained in the unbound model), by using the specific Business process steps and data characteristics specified in the Custom Model together with constraints specified in the Application Constraints Model.

“Custom Model” means a customized general model of a business process to reflect specific business requirements.

“Deployed Model” means a bound model with the binding information for the management services running in the system.

“Candidate Grounded Model” can be an intermediate model that may be generated by a tool as it transforms the Unbound Model into the Grounded Model.

“Grounded Component” can contain the installation and configuration information for both Grounded Execution Components and Grounded Execution Services, as well as information about policies and start/stop dependencies.

“Grounded Execution Component” can be a representation in the Grounded Model of a (worker) process, thread or servlet that executes an Application Component.

“Grounded Execution Service” is a representation in the Grounded Model of the entity that manages the execution of execution components such as Work Processes, servlets or database processes.

“Infrastructure Capability Model” can be a catalogue of resources that can be configured by the utility such as different computer types and devices such as firewalls and load balancers.

“MIF (Model Information Flow)” is a collection of models used to manage a business process through its entire lifecycle.

The term “virtual” usually means the opposite of real or physical, and is used where there is a level of indirection, or some mediation between the resource user and the physical resource.

The distinctive features of embodiments of the present invention can be applied to many areas, the embodiments described in detail can only cover some of those areas. The areas can encompass modelling dynamic or static systems, such as enterprise management systems, networked information technology systems, utility computing systems, systems for managing complex systems such as telecommunications networks, cellular networks, electric power grids, biological systems, medical systems, weather forecasting systems, financial analysis systems, search engines, and so on. The details modelled will generally depend on the use or purpose of the model. So a model of a computer system may represent components such as servers, processors, memory, network links, disks, each of which has associated attributes such as processor speed, storage capacity, disk response time and so on. Relationships between components, such as containment, connectivity, and so on can also be represented.

An object-oriented paradigm can be used, in which the system components are modeled using objects, and relationships between components of the system are modeled either as attributes of an object, or objects themselves. Other paradigms can be used, in which the model focuses on what the system does rather than how it operates, or describes how the system operates. A database paradigm may specify entities and relationships. Formal languages for system modelling include text based DMTF Common Information Model (CIM), Varilog, NS, C++, C, SQL, SmartFrog, Java, Groovy or graphically expressed based schemes.

Model Based Approach

A general aim of this model based approach is to enable development and management to provide matched changes to three main layers: the functional steps of the process, the applications used to implement the functional steps of the process, and configuration of the computing infrastructure used by the applications. Such changes are to be carried out automatically by use of appropriate software tools interacting with models modelling the above mentioned parts. Until now there has not been any attempt to link together tools that integrate business process, application and infrastructure management through the entire system lifecycle.

Model-Based technologies to automatically design and manage Enterprise Systems—see “Adaptive Infrastructure meets Adaptive Applications”, by Brand et al, published as an external HP Labs Tech Report: http://www.hpl.hp.com/techreports/2007/HPL-2007-138.html

and incorporated herein by reference, can provide the capability to automatically design, deploy, modify, monitor, and manage a running system to implement a business process, while minimizing the requirement for human involvement.

A model-based approach for management of such complex computer based processes will be described. Such models can have structured data models in CIM/UML to model the following three layers:
Infrastructure elements, such as physical machines, VMs, operating systems, network links.
Application elements, such as Databases, application servers.
Business level elements, such as functional steps of business processes running in the application servers.

A model is an organized collection of elements modelled in UML for example. A goal of some embodiments is to use these data models for the automated on-demand provision of enterprise applications following a Software as a service (SaaS) paradigm.

A model manager in the form of a Model-Based Design Service (MBDS) can be responsible for the creation of a set of models of the system, each with slightly different parameters for selection, configuration, and evaluation possibilities. The design process can be simply regarded as a search for and selection of the best model, usually in terms of finding the least expensive model which meets the functional and non-functional requirements of the system.

Lifecycle of the Service

Particularly for high end shared infrastructure examples supporting up to one million high value service instances, it is assumed that service providers specify their functional and non-functional requirements but it is the responsibility of the infrastructure provider to render to an appropriate software and infrastructure configuration for the service instance to meet these requirements, and to alter the service as these requirements change during the lifecycle of the service. Rather than the lifecycle (in terms of how to develop the service through its transitions from one development state to a next state) being a predetermined function of the requirements and environment, it is now recognised that this function can itself be adaptive, both to collected requirements and to analysis of how to meet those requirements. The definition of the lifecycle of a service can include the creation and adaptation of a service design that is optimised to meet customer requirements.

The model-based approach presented in the examples described below enables a high level of automation in service lifecycle management, but it is not an automation platform in itself. Rather, a service which is created and managed will typically leverage one or more automation platforms.

Models are a good way to represent the design of a service as desired state. Models are used to manage the service via the use of tools that effect changes to entities in the real world to match the desired state described in the model. The models themselves are stored in a model repository, that is available for read, write, and update by the tools. Models encode a number of important aspects of the service:
The design of a service, regarded as the desired state for the system. The design will include the configuration of the hardware and software entities that comprise the service.
Models may also encode the expected behaviour of the system to allow the actual behaviour to be predicted via simulation.

The management of models in the model repository should efficiently support the following characteristics of the multi-state design process:
The design gets refined through the service development stages, by adding a greater level of design detail and by searching through design space to find good solutions.
At any state, multiple variants of the design can be tried and evaluated during the transition to the next state. Evaluation can be performed analytically via simulation, or from real-world measurements obtained from test services.
Design is inherently iterative. While evaluating design possibilities within a particular service state, it may be discovered that a design cannot be created to fulfil the (possibly modified) requirements, using on design decisions made in an earlier state. It is therefore necessary to cleanly return the model to that earlier state and try alternative variants.

A problem addressed by at least some of the embodiments described, is how to best manage the models in the model repository to efficiently perform the service design optimisation process described above. There are two main aspects to the problem. Firstly the time taken to find an optimal solution for the service design, is reduced by adding parallelism in the search and evaluation process. Secondly, navigation through design space is simplified by easily restoring the model to previous states, in order to try other design alternatives.

Service Design Process

The design of the hardware infrastructure and software landscape for large business processes such as enterprise applications is an extremely complex task, requiring human experts to design the software and hardware landscape. Once the enterprise application has been deployed, there is an ongoing requirement to modify the hardware and software landscape in response to changing workloads and requirements. This manual design task is costly, time-consuming, error-prone, and unresponsive to fast-changing workloads, functional requirements, and non-functional requirements. The embodiments describe mechanisms to automatically create an optimised design for an enterprise application, monitor the running deployed system, and dynamically modify the design to best meet the non-functional requirements. There are two basic inputs to the design process:
Specification of functional requirements. Typically, this is in the form of a set of business steps that the application is to support. These describe what the system is intended to do from the perspective of end users. The specification will specify the set of standard business steps required from a standard catalogue, and any system-specific customisations of these steps. This specification will determine the set of products and optional components that must be included in the design of a suitable software landscape for the enterprise application.
Specification of non-functional requirements. This defines the requirements that the design must meet, such as performance, security, reliability, cost, and maintainability. Examples of performance could include the total and concurrent number of users to be supported, transaction throughput, or response times.

The design process involves the creation of a specification of the hardware and software landscape of the enterprise application that will meet the functional and non-functional requirements described above. This specification can consist of:

a) A set of physical hardware resources, selected from an available pool. The infrastructure can consist of computers, memory, disks, networks, storage, and other appliances such as firewalls.

b) A virtual infrastructure to be deployed onto the physical resources, together with an assigned mapping of virtual infrastructure to physical infrastructure. The virtual infrastructure must be configured in such a way to best take advantage of the physical infrastructure and support the requirements of the software running on it. For example, the amount of virtual memory or priority assigned to a virtual machine.

c) A selection of appropriately configured software components and services, distributed across the virtual and physical infrastructure. The software must be configured to meet the system specific functional requirements, such as customisations of standard business processes. Additionally, the software must be configured to best make use of the infrastructure it is deployed on, while meeting both the functional and non-functional requirements. Configuration parameters could include the level of threading in a database, the set of internal processes started in an application server, or the amount of memory reserved for use by various internal operations of an application server.

Typically, designs are not arbitrary. Instead they follow best-practise patterns from knowledge distilled from human experts. A design pattern describes the essence of a design in the form of an abstract topology of the relationships between the required software and hardware entities. The design pattern may have a number of degrees of freedom, allowing some aspects of the design to be determined in an optimisation process. The process of optimising a design for a service includes the steps of:

a) Selection of appropriate quantities and types of physical and virtual infrastructure and software components, examples can include: numbers of computers of a particular type, the number of application servers running on a computer.

b) Selection of appropriate configuration parameters for the infrastructure and software components and services. Examples can include: required CPU power or memory of a computer, bandwidth of a network connection, number of threads running in a software component.

### INTRODUCTION TO EMBODIMENTS OF THE INVENTION

At least some embodiments of the invention provide a mechanism to manage changes to a model of a service, so as to provide some consistency with the requirements. The specification that leads to the generated design can include a matching set of allowed operations and policy that modify the service configuration, allowing the service to adapt to changing requirements. The set of allowed operations and policy for how and when to apply those operations can maintain conformance to the original requirements and thus reflect design strategy choices.

An increasing proportion of Information Technology (IT) infrastructure is being purchased as a service from hosting providers. In the Software as a Service (SaaS) paradigm a service provider offers a service to the customer that includes not only management of the software but also the infrastructure, both physical and virtual, it runs on. Software providers provide software that can be packaged and offered as a service by the service provider. Customers contract with the service provider to consume an instance of a service.

Services can be offered by the service provider over the Internet on a large scale to thousands of customers. The motivation for the SaaS paradigm is that the costs of running the service are amortized by the service provider across all of its customers, minimizing the cost and overhead to the consumer of the service. However, this is more viable economically if the service provider can automate the management of the service to be able to offer the service at a lower cost and better efficiency than the customer could provide it themselves. Each potential customer may have specific requirements for the service, both functional and non functional.

Services do not conform to a one size fits all approach. A service provider must be able offer multiple variants of a service, whose operational behaviour and design are targeted to the customer requirements. Additionally, circumstances change. The requirements of the customer and demands placed on the service may evolve over time. For example, the number of users placing load on a service may suddenly increase at the end of a month to meet month-end deadlines. The design configuration of the service must adapt to these changes.

Designing and managing an IT system to support a service is a complex, error-prone activity that requires considerable human expertise, time, and expense. Automation of this process can involve using best-in-class strategies distilled from human experts. The process of maintaining a design for an IT service can involve creating an optimal configuration of hardware and software resources that best meet the current requirements. Typically designs follow a best-practise pattern generated from past experience. As the requirements of a service may change over time, this optimisation can be a continuous process. To continue to meet these requirements, the design of the service may also need to change.

Some of the embodiments described below are concerned with a mechanism to efficiently manage the lifecycle of a computing service by performing a coordinated sequence of actions on models of a service, stored in a model repository, to iteratively refine the service design encoded in those models. The progression of the service lifecycle can be made more efficient by the use of actions that operate on the model repository itself to perform versioning, cloning, and archiving of the models stored in the model repository.. The policy and mechanisms for how to refine the design can be incorporated in a template as a part of the design. Modifications to the design may be required either as a result of changes in customer requirements such as response times, or because of necessary maintenance activities such as the application of patches. Changes to the service may occur either automatically or initiated by human service administrators. Crucially, service administrators must not be allowed to request changes that may compromise the integrity of the design.

At least some of the embodiments involve a model manager having:

a generating part arranged to generate variants of the model by automatically choosing values for a limited set of design variables, and an evaluating part for evaluating the variants in operation, the model manager being arranged to store in a model repository a current variant and at least some previous variants, and their evaluation results and derivation trails indicating how the variants are derived from each other, the generating part being arranged to use the evaluation results and the derivation trails to generate a next current variant by making new choices of values, or by reverting to one of the previous variants. Such use of the repository can help make more efficient the search by the model manager for variants that work well. In particular the derivation trails and evaluations can make it easier to determine when to revert to a preceding variant, if successive evaluations are not improving. Also the evaluations and trails can make it easier to determine what new design choices to try next, since the repository indicates which design choices have been made and which remain to be evaluated. This can lead to faster development, or development of more complex services, where the design space is large and more difficult to search efficiently.

More efficient management of the lifecycle of a computing service can involve performing a coordinated sequence of actions on models of a service, stored in a model repository, to iteratively refine the service design encoded in those models.

Iterative refinement can involve extending, exploring, and evaluating the design expressed in the model and progressing the model through well-defined states that correspond to the stages of the service lifecycle. The refinements can be made via scheduled actions that create, update, and delete individual entities in the model; where these entities correspond to the various elements of the design of the service, such as hardware resources and software components, and specify how they should be configured. The sequence of actions to be performed, for both models and the model repository, can be specified as structured sets of Change Requests that in some cases are themselves stored in the model. Thus the model specifies how to change itself, and how to perform the optimisation search through design space.

Notably, progression of the service lifecycle can be made more efficient by the use of actions that operate on the model repository itself to perform versioning, cloning, and archiving of the models stored in the model repository.

In some embodiments the variants can be generated from a template of a model of the service, parameterised by requirements and also representing allowed operations to change the model, parameterised by requirements. A consequence of such a template representing allowed operations to make changes is that the designer of the template for the service can limit subsequent changes as appropriate, and having the changes made according to the same requirements as are used for the model can help reduce a risk of introducing changes which are inconsistent with the requirements. This in turn can enable more complex services to be developed, or reduce development costs for example. Having the parameterised allowed operations in the same template used for the model can make it easier to manage changes to the model.

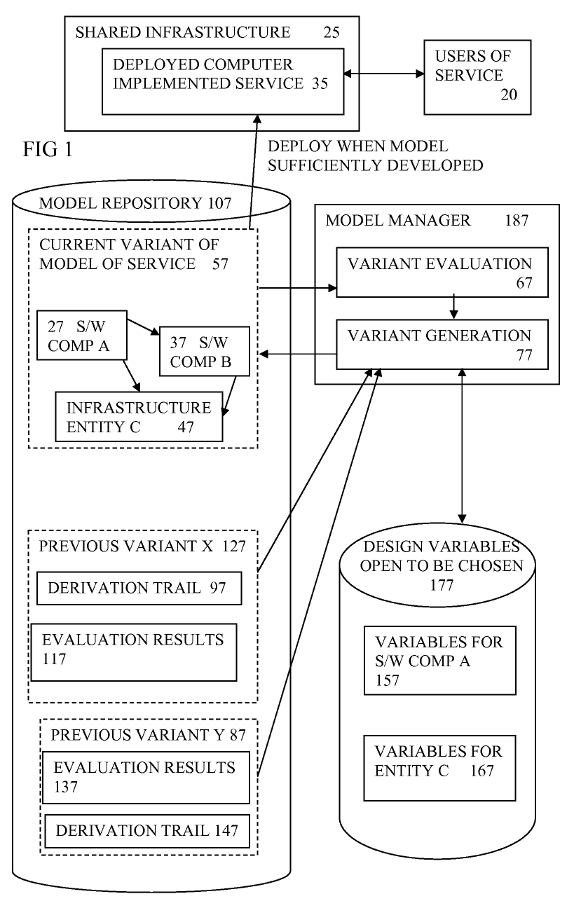

FIG. 1, a System According to an Embodiment

The embodiments described show mechanisms to specify and automate changes to a service. Some embodiments are capable of adaptively automating changes to a service at various stages of its lifecycle. A typical lifecycle may include collection of service requirements, design of an appropriate hardware and software infrastructure to meet those requirements, through to deployment of the design to create a running service. It is assumed that management of the service is model-based. Management operations update a service model, an example of which is a Service Lifecycle Model (SLM), associated with a specific instance of the service. These updates to the service model may cause tools to perform actions on the system under management to change the state of the system to reflect the desired state described in the model.

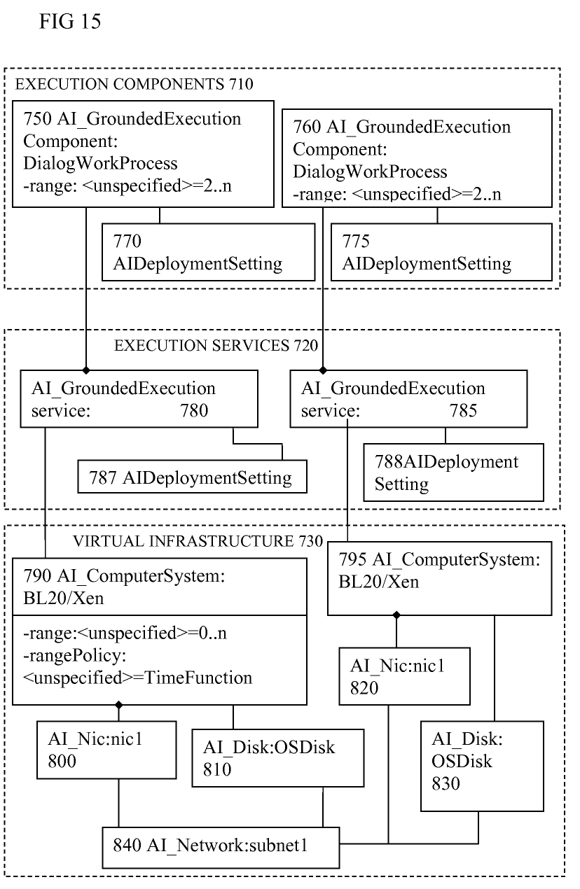

FIG. 1 shows a deployed computer implemented service 35 deployed on shared infrastructure 25 provided by an infrastructure provider. The deployed service is used by users 20. The deployed service is deployed according to a current variant 57 of the service model. This model has a number of entities, three are shown as examples, there would typically be many more. A software component A 27 is shown coupled to another software component B 37. Both make use of infrastructure entity C 47 which could be a virtualized storage or processing or operating system entity for example. Other examples can be envisaged, and other examples are shown in FIG. 15 described below.

The model is generated and evaluated by a model manager 187. This is shown as having a part 77 for generating a current variant, by automatically choosing values for design variables. This can be by reference to a store 177 of design variables free to be chosen for a given entity in the model. In principle this store can be part of the model. As shown it has variables 157 for software component A 27, and variables 167 for entity C 47.

Previous variants can be stored in the model repository. An example variant X 127 is shown, having a derivation trail 97, and associated evaluation results 117. This information can be used by the variant generation part if it is desired to revert to a previous variant, or to show what design choices have already been tried. Another previous variant Y 87 is also shown, having its evaluation results 137 and derivation trail 147.

Additional Features

Some examples of additional features which will be described in more detail below and provide basis for dependent claims are as follows:

The evaluation part can be arranged to evaluate more than one of the variants in parallel. This can lead to increased speed of finding a sufficiently good variant during the development. The model manager can be arranged to determine that one or more of the previous variants are unlikely to be useful and to delete them from the repository. This can help to maintain the repository with more efficient use of storage resource and optionally maintain the derivation trail information to enable the previous variant to be rebuilt later.

The evaluating can involve evaluating how well the model meets given requirements for the service. This is one of the most fundamental ways of evaluating services directly. Requirements can change and the development may need to continue in that case.

The generating part can be arranged to develop the model through a number of states of development, with variants being associated with a given one of the states and each of the states having a different set of design variables. This is useful to break the optimisation into more manageable phases, so that each phase can have fewer variables to make optimisation easier and more efficient.

The model manager can be arranged to store as part of the derivation trail other possible trails between any variants of any of the development states to enable reversion along the other possible trails. This can make it easier to revert to a previous development state, as it enables “leap frog” reversions to for example a much earlier variant without needing to recreate in reverse all the intermediate variants between that much earlier variant and the current variant.

The model manager can be arranged to generate a variant in the form of a clone model of the service from the model, the clone model having its own clone model repository, and to develop the clone model separately from the development of its parent model. This means the clone can have its own derivation trails and can be reverted and so on independently.

The model manager can be arranged to deploy the model and deploy one or more of the clone models to run their corresponding services in parallel. This parallelism helps enable faster evaluation.

The deployed model and the deployed clone model can have monitors, and the model manager be arranged to develop the corresponding services in parallel according to an evaluation of the outputs of the monitors compared to given requirements for the service. Such developing in parallel can be more efficient than serial type development.

The clone model can have a lifespan independent of that of the parent model. This can enable useful parts to be maintained for re-use. A catalogue of at least partially designed services can then be stored in the model repository that can be used by other customers so that the search effort to achieve that design does not need to be repeated. The alternative of dependent lifespan is feasible, meaning that if the parent service is destroyed the child clone is also destroyed. This can ease the task of maintenance and reduce waste of storage resource.

The model manager can be arranged to record a complete snapshot of at least one of the variants in the model repository, and the model manager being arranged to revert the model to a preceding variant according to the snapshot. This can enable faster and more reliable reversion than having to rebuild the variant from for example records of actions or indications of derivations from a previous variant.

The model can also represent a configuration of software components to implement the service, and allocations of infrastructure resources to run the software components. This can help enable more complete modelling of factors affecting operation and so is likely to lead to better provision of services, particularly where infrastructure is shared.

The model can also have an indication of allowed adaptation behaviour of the service. This can help constrain the changes to the service to ensure consistency. Having this indication in the same model can make it easier to manage. The system can have a deployment part arranged to deploy the service on shared infrastructure according to the model.

The service model can have a representation of at least a design of the service, a configuration of software components to implement the service, and a configuration of computing infrastructure for running the software components. This can help provide a more complete model and so enables more predictable and reliable implementation.

The service model can have a representation of at least a design of the service, and a configuration of software components to implement the service, with the monitoring being provided at a software component level. This can help provide information closer to the experience of users of the service.

The service model can have a representation of at least a design of the service, and a configuration of software components to implement the service, and computing infrastructure for running the software components, with the monitoring being provided at a computing infrastructure level. This can help provide information to help make the infrastructure configuration more efficient in use.

The allowed operations can comprise changes to the service design, changes to the configuration of software components and changes to the configuration of computing infrastructure. This can help ensure consistency of changes at multiple levels in the model, and thus make the management of the service easier, or help enable more complex models to be managed.

The system can be arranged to provide automated deployment of the service on shared infrastructure according to the service model. Such sharing helps provide efficiency of use of infrastructure resources, and automated deployment helps make ongoing management of the service easier, and can help reduce human input and reduce the risk of inconsistencies being introduced.

The requirements can comprise functional requirements and non functional requirements to enable the changes to be consistent with a wider range of requirements.

The template can further comprise a representation of how to get the requirements. This can help ensure that appropriate requirements are captured, which can make management of the service easier or enable more complex services to be managed.

Two kinds of Change Management operations in particular are supported by the embodiments, others can be envisaged:
Adaptation. The service design may need to change in response to changing requirements and demands. For example, the number of application servers may be increased to cope with increased demand, or the amount of virtual memory allocated to a virtual machine may be increased to maintain response times.
Run-time maintenance. A service will typically need periodic maintenance tasks to keep the system healthy - for example software patches, version upgrades, backup, disk defragmentation, management reports, antivirus scans, etc. Some of these changes will modify the design, but others are simply maintenance of the same design. For example application of a software version upgrade or patch can be thought of as a modification to the service design, but disk defragmentation is not. Two sources of change initiation in particular are supported, again there may be others that can be supported:
Automated. Changes can be automatically initiated in response to monitored conditions and changing requirements. These requested changes may still require human approval. The closed loop management for the service decides whether action is required and the choice of action to take, and is driven by service-specific policy and automated decision making. Notably the design of the closed-loop-management policy for the service can be matched to the customer requirements and matched with other aspects of the design.
Manual. Change can be initiated by administrators of the service. A key aspect of some embodiments of the invention is that the design of the set of operations available to the administrator, when they are applicable and the parameters they can take, is itself part of the design process.

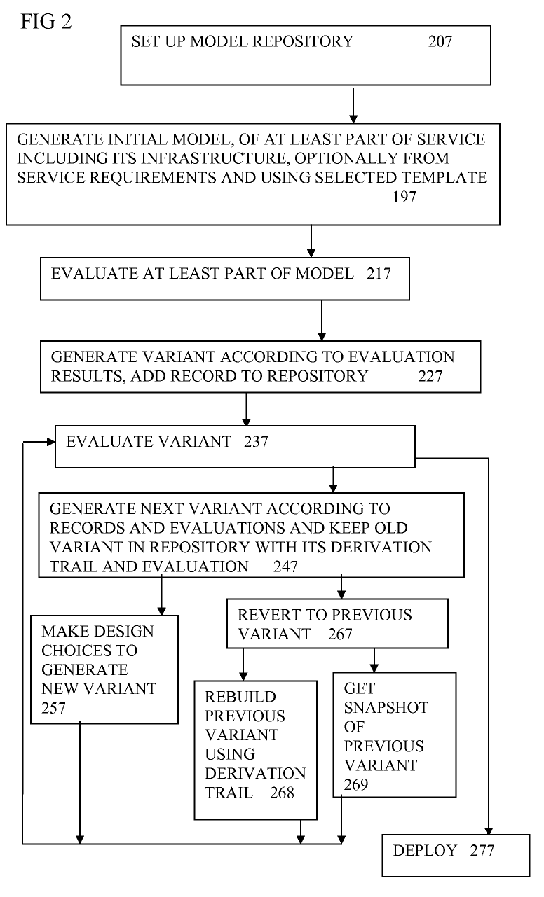

FIG. 2 Steps according to Another Embodiment,

FIG. 2 shows steps according to an embodiment. It includes a step 207 to set up a model repository, step 197 to generate an initial model of at least part of service including its infrastructure, optionally from service requirements and using a selected template. A subsequent step, 217, is to evaluate at least part of model, and then generate a variant according to evaluation results, and add a record to the repository at step 227. This variant is evaluated at step 237. Step 247 is to generate a next variant according to records and evaluations and keep the old variant in the repository with its derivation trail and evaluation information at step 247. This leads either to step 257, to make design choices to generate new variant, or to step 267 to revert to a previous variant.

This can involve either rebuilding the selected previous variant using information from the derivation trail at step 268, or getting a snapshot of the previous variant at step 269. Then step 237 of evaluating, can be repeated, and the process continued until the stage of deploying at step 277 is reached if the evaluation is good enough.

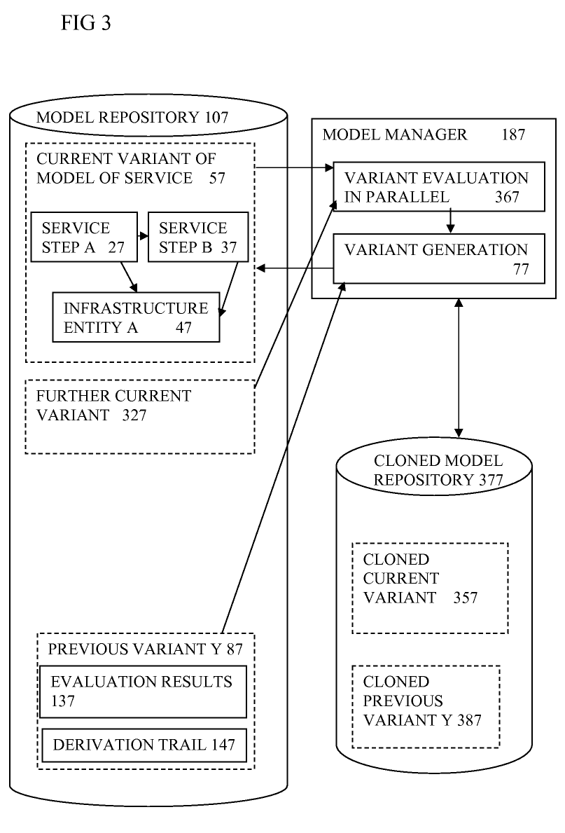

FIG. 3 another Embodiment having Evaluation in Parallel

FIG. 3 shows another embodiment in which similar features to those of FIG. 1 are shown, and the same reference numerals are used as appropriate. In this embodiment a further current variant 327 is shown, and the evaluation part 367 is shown evaluating both variants in parallel. Also shown is a cloned model repository 377, having a cloned current variant 357 and a cloned previous variant Y 387. This can be generated and evaluated in parallel with the parent model, by the model manager.

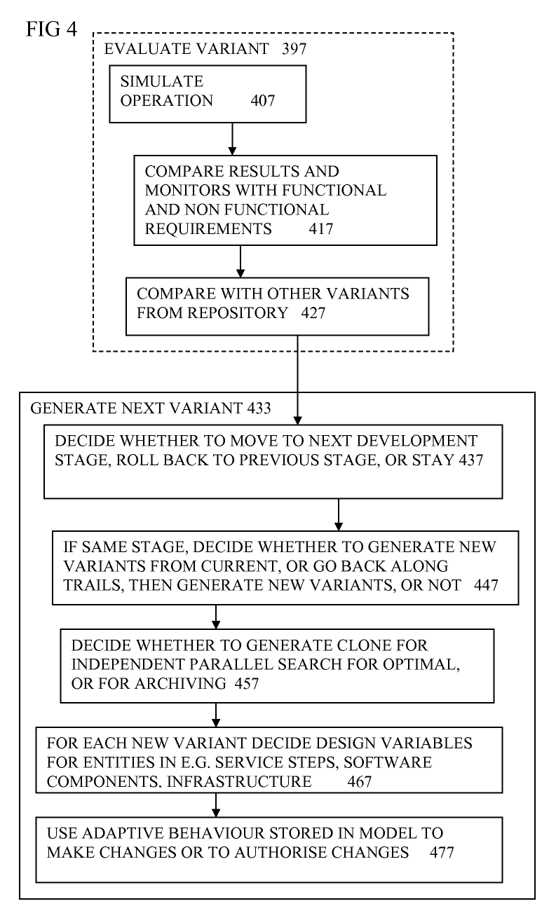

FIG. 4 another Embodiment having Evaluation and Generation of Variants,

FIG. 4 shows another embodiment, showing an example of some of the principal actions of the evaluation 397 and generation 433 functions of the model manager. At step 407, operation of a variant is simulated. Results and monitor outputs are compared at step 417 to functional and non functional requirements of the service, and compared at step 417 with those from other variants to find a more optimal design.

The output of that step is fed to step 437 of the generating function which involves deciding whether to move to a next development stage, roll back to a previous stage, or stay in the current stage. If the same stage, at step 447, there is a decision as to whether to generate new variants from the current variant, or revert to a previous variant. Either that previous variant can be taken as the current variant, or new variants can be derived from it. Step 457 then or at any time, involves deciding whether to generate a clone for independent parallel search, or for archiving for future use of all or parts of it. For each new variant, at step 467, there is a decision of what values to give to design variables in e.g. functional steps, software components or infrastructure. At step 477, adaptive behaviour stored in the model can be used to make or authorise changes to the model.

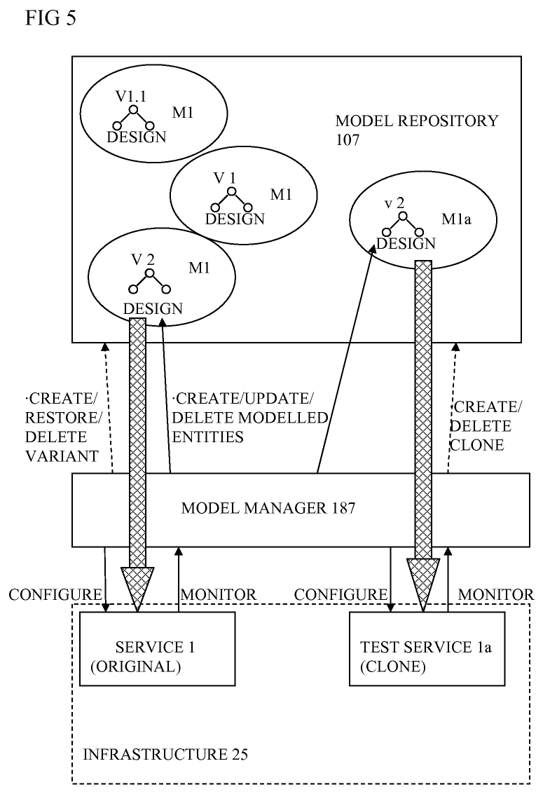

FIG. 5 Shows another Embodiment Showing Deployment of a Clone,

FIG. 5 shows several variants of a model M1 of a service instance stored in the model repository 107. A model-based management layer, shown as model manager 187 is responsible for controlling the progression of the service model through the various states, optionally according to the instructions encoded in the model as Change Requests, described in more detail below.

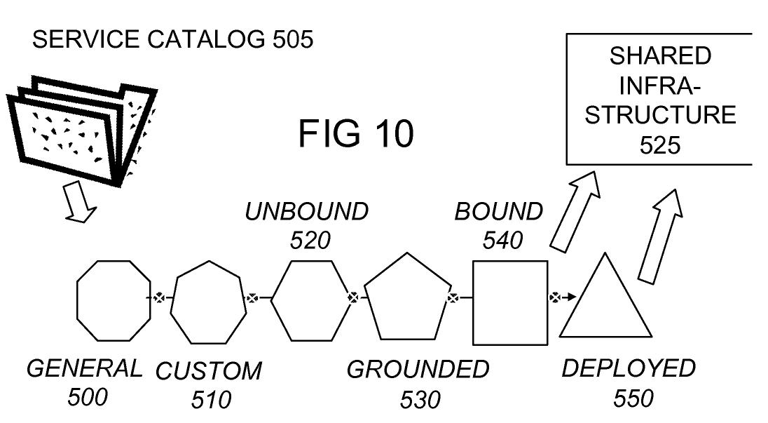

The service instance could be managed in a linear fashion from left-to-right through the state transitions such as those illustrated in FIG. 10 described below, using only actions that operate on the entities within the model itself—the Create, Read, Update and Delete (CRUD) operations illustrated in FIG. 5 by arrows. However, the design optimisation process can be made more efficient and easier to implement by the use of actions that operate on the model repository itself, shown as dotted line arrows in FIG. 5. Examples of the use of model repository operations include:
Model versioning, used to create sub-branches (minor variants) that allow tools to work semi independently to explore and evaluate design possibilities within that branch. This allows the tools to work in parallel, thus decreasing the time taken to search the complete design space.

This use of minor variants is analogous to having multiple engineers working in a software development team working independently on their own branch of a source code repository. Creation of minor variants is illustrated in FIG. 5 by the model with variant V1.1, which is a branch of variant V1.
Model versioning is also used to snapshot the service model at important points in the progression of the service lifecycle. For example when the model completes the transitions to a new state a new major variant of the model may be created. This is useful during the iterative design process when the service lifecycle may need to be brought back to a previous state, perhaps to change customer requirements or to explore a different design alternative. Because the previous state of the model has been saved in a variant snapshot, this can be implemented as simply restoring an earlier variant of the model. Creation of major variants is illustrated in FIG. 5 by the model with variant V2, which is a progression of model V1 to a new service state.
Model cloning is used to create independent models that can be independently progressed through their lifecycle states. This is useful for example to try out design alternatives on one or more test systems in the form of services deployed on infrastructure 25 according to the model. Each test system would be a clone of the original service model, and could be taken to the deployed state. Each test system would be deployed in parallel, as shown by the arrow labelled configure. The service can be driven from an automated benchmark load, and monitored by the model manager to evaluate how well that design alternative meets the requirements. Because the test systems are deployed in parallel, exploration and evaluation of the design space can be achieved more quickly and accurately. Creation of a new clone is illustrated in FIG. 5 by the model MI a, which is a clone of V2 of M1.

Some of the model repository actions may not be confined only to effects on the model repository. Depending on the state of the model, the actions may also imply additional side-effects in the infrastructure 25 under management. For example cloning a model in the Bound state, ready to deploy a new system, implies the acquisition of new physical computing resources such as computer systems, disks, and networking, on which the cloned service can be deployed.

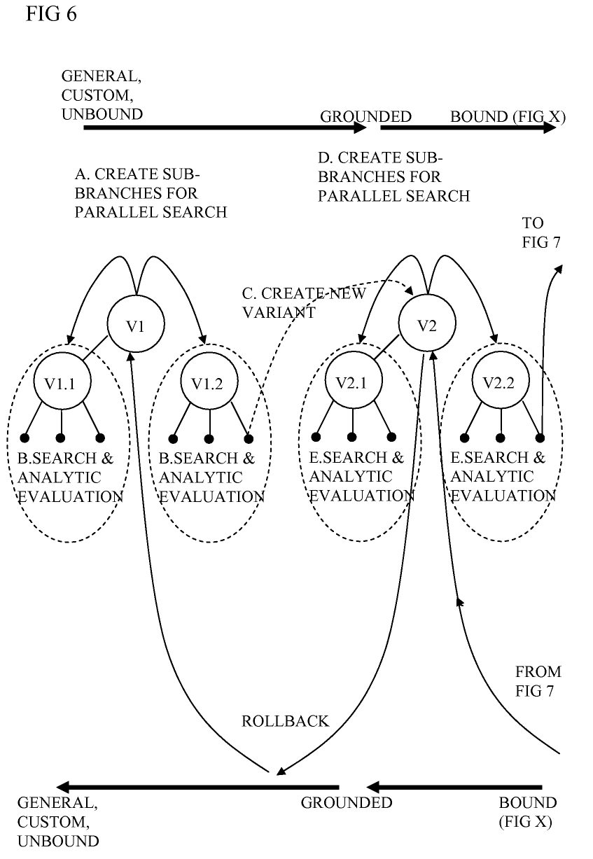

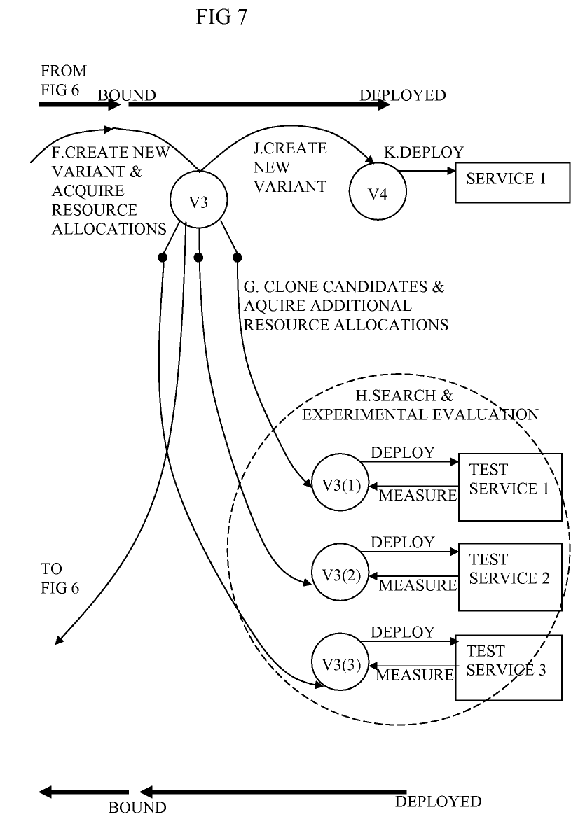

FIGS. 6 and 7 a Schematic View of a Structure of Derivation Trails of Variants during Different Development Stages according to an Embodiment

Some state transitions only affect the model because they take place entirely in design space. In the Model Information Flow illustrated in FIG. 10, all state transitions up to the Grounded state take place purely in design space. Right-to-left transitions between these states can be implemented purely by restoring the model to a previous variant created for that state.

Other state transitions require more complex processing because they have a side-effect on the real world. For example the Grounded-Bound transition results in resources being acquired, while the Bound-Deployed transition results in for example computers being deployed and booted, and software installed and started. For these states there is a direct-coupling between a model and a system under management in the physical world. When the model is in one of these states, parallelism can only be achieved by cloning the model to create a distinct cloned instance of the model. Here each clone corresponds to a different system under management.

FIGS. 6 and 7 show use of model operations during the progression of service lifecycle, for some of the state transitions of FIG. 10. The service states, stored in the model, are shown across the top of the figures. The figure shows an example of derivation trails between different variants associated with different development states. Each trail to a next variant represents a set of operations that are performed. In some cases the trail involves a transition between states. From the perspective of the abstract model operations, design refinement and analytic evaluation, the transitions between the General, Custom, Unbound, and Grounded states can all be treated in a similar way, because they apply purely to a model of the service—there are no physical resources or side effects. Therefore, for compactness not all of the state transitions are shown in the figure—the General, Custom, and Unbound have been collapsed into a single state, but the abstract operations shown in the transition to the Grounded state would also apply for example to the General-Custom transition.

Unbound-Grounded Transition. The transition to the Grounded state involves the exploration of multiple design alternatives, and the evaluation in parallel of several alternative variants against the requirements for the service at step B. Since the service is not yet deployed, only analytic evaluation can be employed. To minimize the time taken to perform this optimization process, the search and evaluation is performed in parallel. Step A shows the use of versioning to create two sub-branches of V1 of the model, V1.1 and V1.2. These may correspond to two major design choices; for example that the SAP system could be designed in a centralised configuration, with both the Database and Central Instance application server on the same computer, or alternatively in a decentralised configuration, with both the Database and Central Instance on different computers. For each of these major design alternatives, there may be many further minor variations. The search through design space within each major variant is carried out in parallel by semi-independent analytic tasks, perhaps by an Automated Performance Engineering (APE) component. Within a branch, APE would explore different design parameters, e.g. amount of memory for computer system or number of instances of software component, using CRUD operations on the sub-branch.

When an optimal solution has been found, in this example a variant of V1.2, the selected design is carried forward into the next (Grounded) state. In addition to setting the service state to Grounded, a new variant of the model is created, V2 as shown in step C. The new variant V2 acts as a snapshot of the model, allowing the model to be easily restored to a previous state to return to the Grounded state with that design variation.

Grounded-Bound Transition. The Grounded-Bound Transition is similar, from the perspective of any required abstract model operations—parallel search through design space at steps D and E and creation of a new snapshot. However, the Bound state implies interaction with the physical world, therefore additional actions are required to acquire allocations for physical computing resources shown as step F.

Bound-Deployed Transition. The Bound-Deployed Transition involves deployment of the hardware resources and software components described in the design. However, before the service is finally offered to customers, it may be desirable to test a physical deployment of the design using an automated test framework to verify the service behaviour predicted by analytic evaluation. One or more clones of the model (V3(1), V3(2) and V3(3)) may be created in the model repository, at step G, each of which is deployed as test services I to 3, and tested using the automated test framework, shown as step H. Each clone requires additional physical resources to be acquired. The decision to clone a model, in order to test a design variation using a physical deployment, can occur in any state of the service lifecycle. The cloned service will simply be transitioned through the remaining states. Thus evaluation of a design variation in a state n, can search through the implied design variation branches that occur in later states. If the tests on the deployed design variation prove to be unsuccessful, then it can revert or backtrack to previous variant for state n, and try different variations. Thus comparison of design alternatives can be made by combination of simulation, real-world measurements, and analytical risk analysis of which variants to test.

Clones can be dependent or independent. A dependent clone shares some aspects of lifecycle with the parent—if service associated with the parent is terminated and destroyed, then the clone would also need to be terminated. An independent clone has a lifecycle that is independent from parent—this would allow full or partial designs to be replicated, archived, and placed in a catalogue for use by other customers.

The following are some of the notable consequences of the features described:
It allows parallelism in the analytic search through design space for an optimal design. This is achieved by creating minor variants of the model in the model repository and allowing each instance of the analytic search components to work on an independent versioned sub-branch of the model.
It allows parallelism in the experimental evaluation of design alternatives. This is achieved through cloning of a model for independent physical deployment.
It allows simple traversal of the search space to revisit earlier design decisions and requirements. This is achieved by snapshoting the model at important decision points to create a variant in the model repository, and reverting the model to an earlier variant to continue the search through design variations.
It allows catalogues of partial or completed designs of a service to be created, for use by other customers. This is achieved by creating and archiving independent clones of a model of a service, whose lifecycle can be managed independently.

Variant Generation Using Templates

The variant generation part can make use of rendering tools and can create or develop the service model based on a template. An example of such a tool is a model lifecycle service (MLS), which can be arranged to use a change request engine CRE as will be described in more detail below. The rendering tool can comprise software tools, or can make use of such tools from external sources to carry out the development, in a partially or fully automated manner. Examples of parts of the template can be the Infrastructure design template IDT and Model State Transition MST described in more detail below. The requirements can be specified at the outset by the service provider and may be updated during the lifecycle. The template can hold a representation of allowed operations to change the model again parameterised by requirements. Examples of allowed operations are described in more detail below.

Some features of the embodiments are first briefly introduced here, then described in more detail with reference to the figures:

A) Model-driven service lifecycle management. The behaviour of the service can itself be specified in the template, an example of which is the Model State Transition (MST). An instance of the MST is associated with an instance of the SLM. The model-based nature of the specification can provide formalism, correctness checking, and adaptivity for service behaviour.

B) Controlled model changes. All service lifecycle management operations specified in the MST can be performed (in some cases exclusively) by a set of tools made available by the infrastructure provider in the form of a change manager 62 which can be part of a service execution platform. Changes to the service model and operations that affect realworld entities can be scheduled for example by the submission to the change manager of a simple model, called a Change Request (CR), which encodes the required change. Change Requests provide a formal way to specify the invocation of a tool to carry out a change, specify preconditions on the applicability of the change, and control dependencies between changes for example.

Because CRs can also specify expected outcome, the effect of performing the specified lifecycle behaviour can be predicted and checked for correctness.

C) Automated planning and execution of service lifecycle. The MST specifies the required set of changes to the service model to progress the lifecycle. The MST can be encoded in the form of a state machine, as sequences of parameterised CRs. The change manager, an example of which is an automated service, the Model Lifecycle Service (MLS), can perform a planning operation, searching through state-space to plan the best way to carry out the required change. All CRs in this “best way” are submitted to part of the manager in the form of a CR Execution Engine CRE 600 that then automates the execution of the CRs.

D) Adaptive behaviour. CRs scheduled by the MLS can make changes to any part of the service model, access-rights permitting, including the MST itself. This allows the behaviour encoded in the MST to be updated at run time, for example to best meet changes to customer requirements.

Such changes can occur at any time in the lifecycle of the service. This allows not only customer specific definition or customisation of service behaviour during the service design phase, but also refinement of the behaviour of a deployed service.

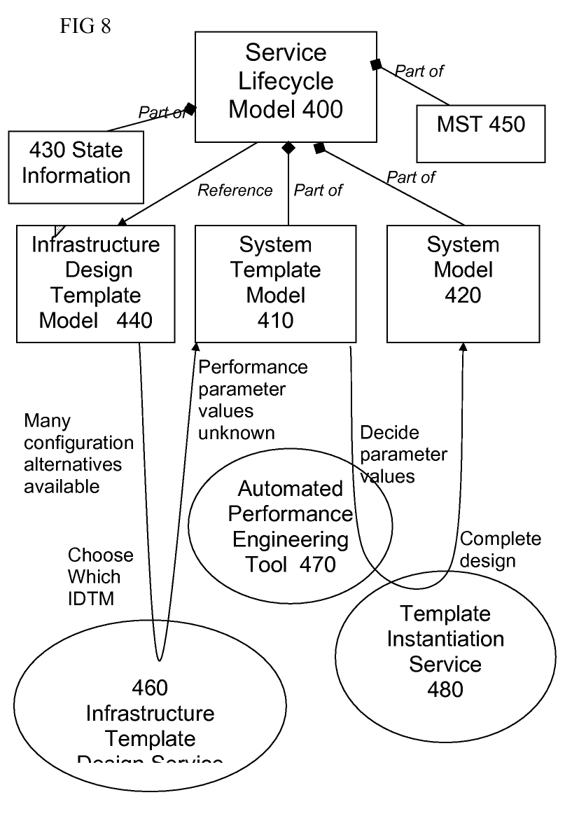

The embodiments described do not assume any specific schema or structuring for the SLM. Instead a set of models and mechanisms to enable automated lifecycle management of the service model, and therefore the service itself are set out. Nevertheless, a specific structuring of the service model (SLM) for an embodiment of the invention will be outlined below with reference to FIG. 8.

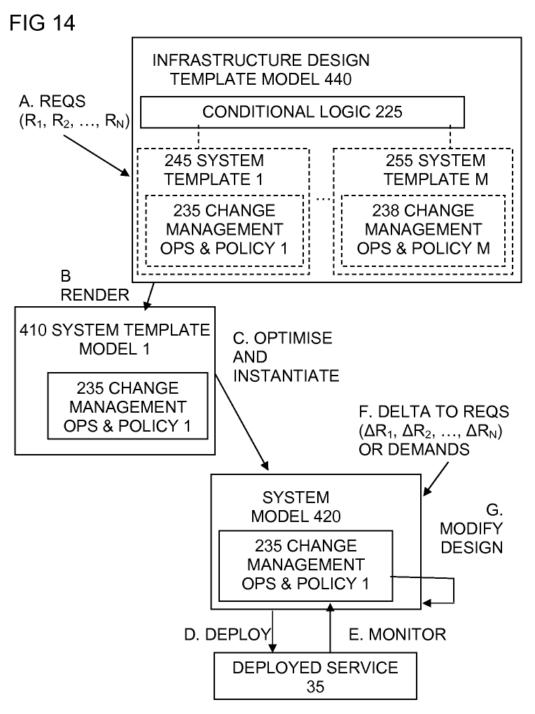

FIG. 14, Example of Service Management having Two Stages of Templates, an Infrastructure Design Template and a System Template.

The design process in this embodiment creates not only the initial design of a service, but also the change management policy and operations by which that design can be modified. An example of a service design process is briefly outlined below with reference to steps A to G represented in FIG. 14:

A. Collect customer requirements. The functional and non-functional requirements of the customer, r1 . . . m, act as input parameters to a parameterised description of a family of best practise design patterns to meet those requirements, the Infrastructure Design Template Model (IDTM or IDT). The IDT contains a textual declarative specification of one or more design patterns. Each design pattern specifies for example the configuration of hardware and software entities of the design. Notably in at least some embodiments the design pattern also specifies the change management operations and policy to modify that design.

B. Render a design template. Instantiate the IDT, parameterised with the requirements, to create a specific design template, System Template (ST), appropriate for the specific service requirements. The IDT contains conditional logic 225 that operates on the input parameters (requirements) to determine how the IDT is rendered to create a specific design template (system template 1 245, to system template M 255) from the family (1 . . . M) of described possibilities. The structure and/or attributes for example of entities of the model can be parameterised. This can mean that the template has logic which makes the instantiation in the system template of the entity, or its relationships or attributes, conditional on the parameter, for example the requirements. Notable for at least some embodiments of the invention is that the change management operations and policy 235, 238 are encoded as part of the template design model and are also configured via the input parameters, and are therefore appropriate to the requirements. The part of the flex policy that defines the allowed ranges for quantities and attributes of modelled entities can involve parameterisation of the System Template (p1, p2, . . . pn), that determines the range of possible the System Models.

C. Optionally, the System Template can be refined by various tools. For example an Automated Performance Engineering tool may modify the default values for p1 . . . pn for the ranges of quantities or attributes of entities in the ST, by analysing the simulated performance of the system. When the parameters of the template have been finalised, the template is instantiated to create the final design of the service, the System Model 420, including the change management policy that was originally selected and specified in the IDT.

D. Reify the design to create a deployed service 35 running on a set of acquired virtual and physical resources.

E. Monitor the service for conformance to requirements. The design template specifies the monitoring points that will act as inputs to the change management system. Both the software and hardware infrastructure can be monitored for example.

F. Service requirements may change, (δr1, δr2, . . . , δrn), or monitoring events may be generated that signal non-conformance to requirements. The change management policy encoded in the template specifies thresholds on monitored data or requirements to trigger change management events.

G. Modify the design. The change management policy in the template also encodes the corresponding rules and actions to modify the service design to maintain conformance to the requirements. For example an application response time event may cause the addition of new application servers; the actual number to be added may be specified in the rule itself, or the rule may trigger invocation of another service, such as an Automated Performance Engineering (APE), to make the decision. APE is a service that uses an analytic model of the behaviour service to perform simulations of the run-time execution, in order to evaluate the performance of the system. Some features are now described in more detail.

Infrastructure Design Template (IDT)

The design process can start with an Infrastructure Design Template (IDT) that captures integrated best-practice design patterns for a service, typically distilled from human experts. The IDT describes the entities contained in the service design, made from a vocabulary of real-world concepts, such as computer system, subnet, or software service. The IDT describes the topology of the service, the essence of a design, in terms of the relationships between these entities.

The IDT can for example specify the following aspects of the design of the hardware and software infrastructure:
The structure and configuration of the hardware (or virtualised hardware) infrastructure such as computer systems, disks, NICs, subnets, and firewalls. The characteristics of the required hardware are specified, such as the type, processing power and memory of a computer system, the bandwidth of a NIC, or the size or latency of a disk.
The internal structure and configuration of the software components or services running on each computer system, in sufficient detail to automatically deploy, configure, and manage them; additionally, the deployment dependencies between the software services, such that they are installed, configured, started, taken on-line, taken off-line, stopped and removed in the correct order.

The requirements collected for the service, r1 . . . m, act as input parameters to the IDT. The IDT can contain conditional logic that references the requirements and determines how the IDT will be rendered to a specific design pattern, the System Template (ST), that meets all of the requirements of the specific service instance. The input parameters provide the ability to encode related families of structural alternatives in a single IDT thereby preventing an explosion in the number of instances of such models. Without this ability, a system characterized by just 7 Boolean choices would, in the worst case, require 27 (128) distinct IDT models that must be maintained separately. IDT models provide a powerful way to model topological alternatives—modules are only instantiated if required and relationships between modules are appropriately configured.

In one possible embodiment, the IDT models can be expressed using the SmartFrog data modelling language. The language provides typing, composition, inheritance, refinement, conditional instantiation, information hiding, and constraints, allowing compact, modular, configurable descriptions of services.

The IDT specifies related families of hardware and software design templates. Notably the IDT can also specify the best-practise change management operations and policy that can be applied to modify the design. This can include any of the following definitions for use by the change manager:
Monitoring points. A specification of the required monitoring data can be attached to any software or hardware entity in the template model. Examples of application-level monitoring include response times, number of users using the system, or transaction rates. Examples of OS or infrastructure monitoring include CPU and memory utilisation, disk I/O, network I/O, or number of operating system kernel threads. Each monitoring point creates a stream of monitored data.
Specification of Monitoring Events. Monitoring events are defined in terms of logical conditions on monitored data streams. For example that a value within a specific monitored data stream has exceeded a specified threshold, perhaps for a minimum period of time.
Allowed operations. The allowed operations that can be applied to extend or modify the model are themselves defined in the model. An allowed operation is specified as a Change Request (CR), attached to the entity in the model that the allowed operation applies to. For example an instance of an allowed CR to change the memory of a virtual machine would be attached to each specific VM that has that capability. In effect the allowed CRs are an encoding of capabilities. CRs specify the circumstances under which change can be applied via pre-conditions, and also specify correctness checking via post-conditions. The logic that defines these conditions can refer to model state, measured data, time, or combinations of all three. Key to maintaining design integrity, the allowed CRs defined in the template also specify:
Parameters to be passed to the CR, with defaults and constraints.
Specification of who is allowed to submit CRs, when, and how.
Corrective actions for failure, such as rollback to a previous design. This specification may be interpreted by UI code to display default values, enforce minimum and maximum inputs, or make a parameter immutable. The allowed CRs can thus enforce the policy for change requests to be submitted by humans.
Design variables in the form of flex points in model. A template defines a system design pattern, by encoding relationships between the entities in the design. It does not necessarily define exact quantities of entities to be in the final design, or values of attributes of those entities. These are the flex points of the design. They allow the design to adapt to changing requirements, and represent the degrees of freedom of the design template. Instead the IDT can specify constraints on the values taken by the flex points, in the form of ranges, or other logical conditions. Examples include:
Ranges of numbers of hardware or software entities. For example 0-50 application servers may be added at a specific point in the network architecture. Another example is that an application server may have between 4 and 16 application threads.
Ranges of attribute values. For example the memory of a database machine may be varied between 4 GB and 32 B, and its CPU power between 2 and 4 units. The operations that apply to the model must respect the constraints defined in the flex points. For example, the CR to add a VM of a particular type to the design, and install Application Software on it, must respect the constraints on the corresponding flex point for that VM.
Policy to connect events with operations. A template defines the logic that connects the generated events to the CR operations that modify the design, to maintain conformance with the principles of the design. Logic determines which operations to perform, when, and parameters to use. The logic may be specified by a combination of one or more of the following:
   Specified directly in the template if not too complex, using a string-based language interpreted by a controller.
   Specified in a supplemental model referenced by the template.
   Specified using named policies understood by one or more well-known controllers. The change management policy encoded in the design template may apply only to the closed loop management of a specific service instance created from the design. The policy logic, visible monitored events, and operations are confined to that service instance. However, an effective closed-loop management system for a platform that is capable of hosting multiple service instances must make decisions with a more global perspective. Therefore, the policy defined in the template must be capable of specifying constraints to be interpreted by multi-service change management controllers.

Consequences of Template-Driven Model-Based Process

The template-driven model-based nature of the design process, and model-based encoding of change management, and features of its implementation can have the following consequences:
The allowed operations for an entity and the policy by which it is applied can be targeted to the domain-specific role of that entity—this is the essence of best practise design. For example a modelled entity representing a Virtual Machine to host a mission-critical database would have a different set of allowed operations and flex policy than an entity for a Virtual Machine hosting an application server. These policies are encoded by experienced human experts but refinable by tools invoked during the design process. For example, a template may specify that in general VMs can be migrated; an Automated Performance Engineering service, invoked during the design process to perform performance sensitivity analysis, may turn off this capability for the entity that runs the database by removing the allowed CR attached to that entity; APE may also further constrain the allowed run-time design changes for attributes such as memory or CPU power by modifying the constraints on the flex points for the VM.
The Change Management policy is appropriate for the functional and non-functional requirements. Conditional logic in the IDT operates on the functional and non-functional requirements to instantiate and configures the appropriate change policy in the generated model.

For example, the logic may state that if the “Gold Performance Stability” non-functional requirement is set then set the flex constraints on the database VM to prevent the memory attribute from being taken below 8 GB.
Changes to the design made by the change management system maintain the intent of the initial design. The design process creates not only the initial design of a service, but also the change management rules and operations by which that design can be modified. The initial design is analogous to the initial state of the universe, and the change management rules are analogous to the laws of physics that determine how the universe evolves over time.
Change management policy can be refined over time by modifying the models. The template can specify which policies can be subsequently modified. Because the refinements to the change management policy are themselves made by tools invoked by the CR mechanism, they still conform to the intent of the original design. Following the previous physics analogy, this is analogous to a set of meta-laws of physics, created from the initial IDT design template, that encode how the laws of physics themselves can be changed. Depending on the stage of the service lifecycle, tools can modify policy either in the System Template or in the resulting System Model; for example it is possible to shrink flex ranges, add or remove CR operations to the allowed list, modify thresholds, etc. The decision for the appropriate changes to be made could be based on:
Analysis of simulated performance sensitivity. For example, APE may turn off the ability to migrate an SAP Central Instance because it causes too much uncertainty in simulated performance.
Analysis of key performance indicators from measured data obtained from the running service.

FIG. 8. Service Lifecycle Model Sub-Models, and Supplementary Models. FIG. 8 shows an example of a system having a hierarchical structure of models with an SLM 400 as a top level model. The SLM is typically composed of additional sub-models, in particular a service model in the form of a System Template Model (STM) 410 and System Model (SM) 420 that respectively specify the best-practise design pattern for the service and the optimised design of the service that is created from this template. An important part of the SLM is a generic repository to hold state information 430, which may be in the form of key-value pairs; this state information will include representations of the requirements collected from the customer. The SLM may also reference other supplemental models, such as security or business process definition models (not shown).

Some of these supplemental models may contain descriptions used to render parts of the SLM; for example an Infrastructure Design Template Model (IDTM) 440 is used to create the STM. These models contain no explicit notion of service lifecycle or behaviour - they simply specify information about the service, and in particular the desired state of the software and hardware infrastructure. However changes to the model may cause tools to effect corresponding changes to the system under management. Another sub model of the SLM is the Model State Transition (MST) model 450. This specifies the behaviour of the service lifecycle, and so is an example of a transition model. An instance of the MST can be created for each service instance and associated with the corresponding instance of the SLM. The relationship of the SLM and MST for the embodiment outlined above is shown in FIG. 8. The service behaviour is determined entirely by the allowed operations represented in the MST and information held in the SLM, thus making the service lifecycle model-driven.

When a service is first instantiated the MST is created for the service instance, bound to the service model, and populated with data that encodes the behaviour of service lifecycle. The MST contains a specification of sequences of parameterised operations that apply changes to the model as the service progresses through its lifecycle.

FIG. 8 also shows the transitions involved in the lifecycle from an Infrastructure Design Template Model (IDTM) through to a System Model. First there is selection of the template (IDTM) configuration parameter values, to fill in the template. These parameters can be provided by the customer and software vendor via functional and non-functional requirements, and are used to guide how the System Template Model is rendered by an Infrastructure Design Template Service 460, from the IDTM.

A second transition in this example involves an Automated Performance Engineering service (APE) 470, which can be used to decide optimal performance parameter values for the System Template Model. A Template Instantiation Service 480 can then be used to create the System Model using the System Template Model and the performance parameter values found by the APE. The System Model can then be used to direct the subsequent acquisition of resources, deployment, and run-time operation for the service instance. Design pattern operations in the Infrastructure Design Template Model propagate through the System Template Model to the System Model. Further supplemental models can be used to guide model transformations and transitions between Service Lifecycle Model states. Such supplemental models are typically specific to particular tools and approaches for addressing non-functional requirements and are not part of the Service Lifecycle Model. A Service Lifecycle Model only includes references to supplemental models. Supplemental models can support for example the Infrastructure Design Template Service, a Security Service, and an Automated Performance Engineering Service, respectively.

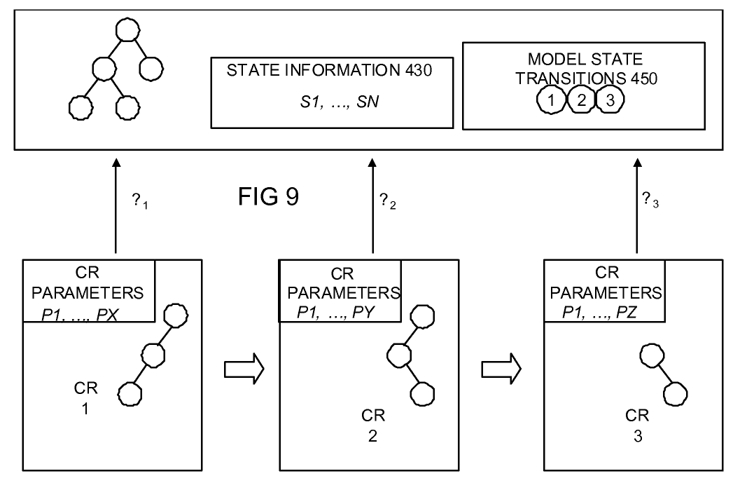

FIG. 9. Changes to a Service Model via sequence of Change Requests. Each processing step involves the invocation of a Change Request (CR) to modify the model. The execution of Change Requests is managed by a CR Engine 600.

The CR Engine resolves a submitted CR to the invocation of a tool registered for that CR to carry out the change. The principle is illustrated in FIG. 9, which shows a sequence of three CRs executed in turn to apply deltas to the model; each CR is passed parameters contained in the MST that affect the operation of the CR. CRs can read and write the SLM, analyse the model, and cause actions in the real world. In particular, CRs create and modify the STM and SM, and carry out deployment operations. The action performed by the CRs can be parameterised by information held in the invocation entry for the CRs in the MST. A typical invocation pattern for a CR is that a parameter refers to a supplemental model containing a declarative description of a set of changes to be applied to the SLM. For example, the Infrastructure Design Template Model is a supplemental model that describes the System Template Model. In addition to the parameters passed from the MST, the action of the CR can be modified by the current state of the information in the SLM. In particular CRs can read and write information as key-value pairs in the State Information store, which acts as a convenient shared store to pass the results of decisions and actions from one step to the next. The MST behaviour model is structured into semantically meaningful collections of related processing steps (CRs).

The MST defines a set of lifecycle states for the service and allowed transitions between those states. The MST also defines the sequence of parameterised CR invocations to transition the lifecycle of the service between each of the defined states. Preconditions can be specified on transitions between states the transition is only allowed if the preconditions are met. Management of the service lifecycle is presented as requests to transition the SLM to a desired state.

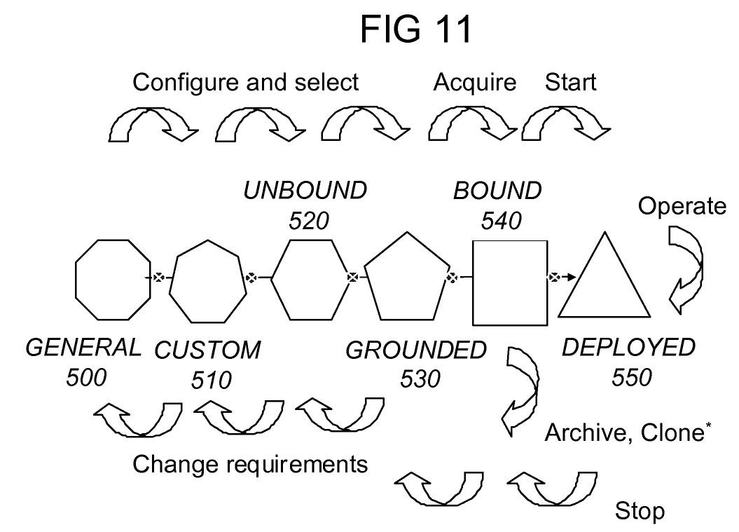

FIGS. 10, 11 Example of service model states (MIF). These figures show a sequence of states of a service model and is refereed to as a Model Information Flow (MIF). It is described in more detail in Brand et al referenced above, and shows lifecycle states referred to as General 500, Custom 510, Unbound 520, Grounded 530, Bound 540, and Deployed 550 models. Each transition between these states would in general involve the operation of many tools, invoked in the order and parameterised as encoded in the MST model. Each of the states is described in more detail below.

Lifecycle management for service instances can include transitions for purposes such as service design, creation, run-time management, and change management. FIG. 11 illustrates transitions for these purposes in service lifecycle management and their relationship to the states.

A Service Lifecycle Model can be in only one state at a time. Tools can be used to provide largely automated transitions of a Service Lifecycle Model from the general state through to the deployed state. Back-tracking is permitted so that it is possible to explore the impact of changes to service configuration and non-functional requirements on the resulting design for the service instance.

As shown in FIG. 11, service design and creation of the service can involve transitions such as “configure and select”, to reach the grounded state. Change management can involve backtracking transitions to earlier states, shown as “change requirements”.

The System Model includes a description of the operations that can be performed on a service instance for run-time management. These correspond to transitions on the service instance when its Service Lifecycle Model is in the bound or deployed state. Bound operations support the acquisition of resources (shown as “acquire”), and “archive” action for archiving a service instance for later use, and a “clone” action for cloning of a service instance. Deployed operations support the configuration and operation of a service instance (shown as “operate”), including operations to vary the number of resources. A deployed service instance can be stopped (shown as “stop”) and returned to the bound state. It may then be started again to resume in the deployed state. A service instance in the bound state may transition to the grounded state. If desired, the instance's computing and or storage resources can be returned to the resource pool (shown by the arrow from the bound to the grounded state).

Cloning can be used to create multiple instances of a service for development, testing, or production service instances. It is an operation in the bound state that creates another service instance with a Service Lifecycle Model in the bound state. The clone can then be started and run in parallel with the original instance. The clone receives a full copy of a service instance's System Lifecycle Model up to information for the grounded state. Different resource instances are acquired to provide an isolated system in the bound state.

The MIF shown in FIGS. 10 and 11 links three viewpoints.

1. The configuration of service functionality offered by a software provider.

2. The configuration of software components that implement the service instance.

3. The configuration of infrastructure, virtual and physical, that hosts service instances.

The MIF enables a change in one viewpoint to be linked to changes in other viewpoints. For example it links a change in selected service functionality or non-functional requirements to necessary changes in application configuration and infrastructure topology. Conversely, model information can also be used to determine the consequences of changes to infrastructure on service instance behaviour.

The MIF is an Example of a Service Model such as a Service Lifecycle Model (SLM).

The Service Lifecycle Model encapsulates service instance specific model information and can evolve through the states shown in FIG. 10 or 11. The lifecycle starts on the left hand side with for example a catalog of services that are supported, and ends on the right with a deployed and running system. Cycles can occur at every step, but are not shown in the figure for reasons of simplicity. The states govern service configuration, infrastructure selection, resource acquisition, deployment and run-time operation of the service instance. The following subsections describe the service catalog and the states of the Service Lifecycle Model in more detail.

Service Catalogue

A service catalogue identifies the services that can be provided. Given an example context of supporting high value enterprise services for a software vendor such as SAP, each entry in the catalog describes a service that is a collection of related business processes. Examples of business processes include sales and delivery, and supply chain management. The description includes textual descriptions and visual notations such as BPMN (Business Process Modelling Notation) to illustrate the business processes. In addition, the catalogue entry specifies a tool-set that supports the creation and management of a corresponding service instance.

Once a service has been selected by the customer (in the sense of the service provider for example) the entry in the catalogue is used to create a Service Lifecycle Model for the service instance. The Service Lifecycle Model can be in one of six states: general through deployed. The Service Lifecycle Model transitions between states as the tool-set operates on the service instance. The following subsections describe the model information that is captured in each state and give examples of tools that are used to support the transition between states.

General

This is the initial state of the Service Lifecycle Model. Once the Service Lifecycle Model data structure is prepared it is able to transition to the custom state.

Custom

The custom state augments the Service Lifecycle Model with functional and non-functional requirements. These requirements are collected by one or more tools in the tool-set.

A functionality configuration tool for the service lets a customer specify the subset of the service's business processes that are to be used. For example, sales and delivery may be needed but not supply chain management. Furthermore, each business process may have several business process variants, i.e., logic that handles different business circumstances. The desired set of business process variants for each chosen process must also be specified. For example, if the customer's business does not accept returned goods then a sales and delivery process variant that supports returned goods would be excluded from the service instance.

Configuration parameters are presented to the customer by the tools that reflect what can be instantiated later. A binary option can be offered for availability which controls whether or not a fail-over pair is created for appropriate hosts in a service instance. A fail-over pair consumes additional resources and may therefore affect cost. Similarly security is offered as a binary option in the current implementation. It controls the subnet architecture of infrastructure and whether or not firewalls are used. A scalability option determines whether a solution is deployed to a centralized solution with a single host or decentralized solution with multiple hosts.

The custom state also gathers customer performance requirements. These are specified in terms of throughput and response time goals for business process variants. The information is used by subsequent tools to support infrastructure design selection and performance sizing.

Once a customer's functional and non-functional requirements for the service are fully specified, the Service Lifecycle Model is able to transition to the unbound state.

Unbound

The unbound state augments the requirements for the system with information from the software vendor. Information from the software vendor includes a description of components needed to support the chosen business process variants. These may include application servers, search servers, and software code artifacts. Knowledge of which components are needed can affect the choice of infrastructure in the next state.

Software vendor information also identifies external software components that are not part of the service being deployed but that are used by the service instance. For example, an order and invoice processing business process variant may require external output management services for invoice printing and credit check services for checking financial details. A tool recognizes which external services are needed, prompts the customer to choose from a list of known service providers, and obtains any additional configuration information from the customer.

Once software vendor specific requirements are completed, the service instance has its requirements fully specified. The System Lifecycle Model is able to transition to the grounded state.

Grounded

The grounded state develops a complete design for the service instance. This includes the detailed infrastructure design, the mapping of software components to infrastructure components and references to configuration data required by the components. One possible implementation uses three tools to refine information from the unbound state to create the design information for the grounded state.

The first tool is the Infrastructure Design Template Service. This tool uses configuration parameters and requirements information collected from the customer and software vendor in previous states to select an appropriate infrastructure design pattern from a collection of design alternatives for the service. The pattern addresses many aspects of the service instance including hardware and software deployment through to operations needed for run-time management. Once the alternative is selected, the Infrastructure Design Template Service initializes a System Template Model for the service instance and stores it in the Service Lifecycle Model. The template is made from a vocabulary of real-world concepts, such as computer system, subnet, and application server.

A System Template Model specifies ranges and default values for performance parameters such as the number of application servers, the amount of memory for each application server, and the number of worker processes in the application servers. Options selected by the customer such as high-availability and security are also reflected in the template, e.g., fail-over pairs and subnet architectures.

A second tool specifies the performance parameters described above. Two implementations to perform this function will be described. This illustrates the flexibility of this approach in enabling alternative tool-sets. The first implementation simply inspects the template for performance parameters and allows the customer to set them. The customer can set a parameter within the range specified, or a default can be selected. The second implementation is an Automated Performance Engineering (APE) Service. It exploits performance requirements and predictive performance models to automatically specify appropriate performance parameter values.

The third tool is the Template Instantiation Service. It takes as input the System Template Model and corresponding performance parameters. It outputs a System Model that becomes part of the Service Lifecycle Model. The System Model is a completed design for the service instance that is expected to satisfy non-functional requirements. Once the System Model is created, the Service Lifecycle Model is able to transition to the bound state.

Bound

The bound state refines the grounded state with the binding to resources, e.g., hosts, storage, and networking from a shared virtualized resource pool. A Resource Acquisition Service interacts with a Resource Pool Management Service from an infrastructure provider to acquire resource reservations according to the service instance's System Model.

In the bound state the service instance can have side-effects on other service instances. It may have locks on resources that prevent them from being used by others and it may compete for access to shared resources. Once all resources have been acquired, the Service Lifecycle Model is able to transition to the deployed state.

Deployed

The deployed state refines the bound state with information about the deployed and running components that comprise the service instance. This includes binding information to management and monitoring services in the running system. A Resource Deployment Service configures and starts the resources. A Software Deployment Service installs the software components specified in the System Model and starts the service instance so that it can be managed. The System Model includes sufficient information to ensure that components are deployed and started in the correct order. A Software Configuration Service loads service configuration data previously obtained from the customer, such as product entries to be added to a database. Finally, the service instance is made available to users.

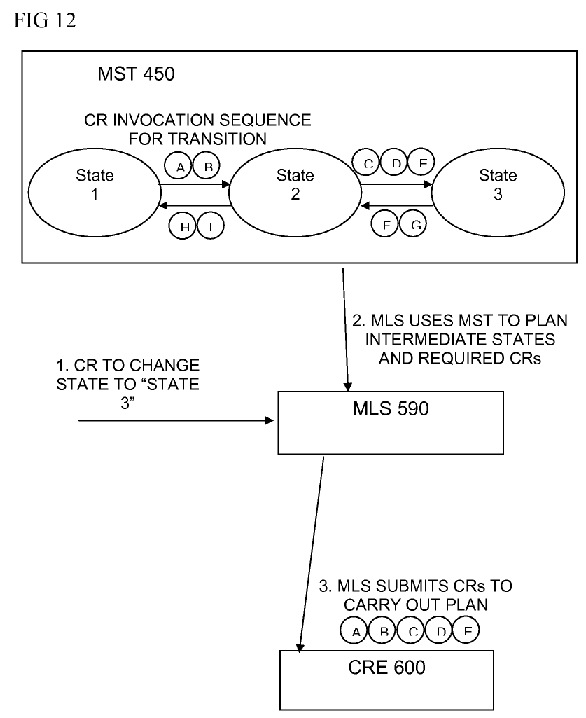

FIG. 12. Use of MST by MLS to plan CRs for transitions of model state. Model transitions can be implemented using a common Change Request (CR) mechanism. The registered tools that carry out the CRs are trusted components. CRs can have good characteristics for predictability, safety, and correctness because of the combination of pre- and post-conditions for integrity checking, with actions performed only by trusted components with well-known behaviour. Since all changes to the model initiated by the MST are performed and mediated via CRs, the effects of carrying out the service lifecycle can also be controlled and checked.

Services can have a palette of CRs available to them to be able to make changes to the model. A service hosting platform can control the set of CRs in this palette. A service instance can extend the set of CRs referenced in the SLM models and MST up to this maximum. The actual subset of CR types used by the MST, and the parameters passed to them, can be encoded in the model. Consequently the effects of executing the MST can be reasoned about. More trusted services may be allowed to dynamically extend the set of CRs in the palette with service specific CRs that reference service-specific tools that are dynamically loaded to extend the platform.

The set of defined states and allowed transitions between them forms a state space for the service. As shown in FIG. 12, a trusted service, the Model Lifecycle Service (MLS) 590, performs the planning through state space to transition the service to the desired end state by submitting a set of CRs in the order, and with the parameters, specified in the MST. To reach the desired state, the MLS may need to take the model through one or more intermediate states. For example in the Model Information Flow shown in FIG. 10, a request to go to the deployed state when the model is currently in the General state involves the sub-goals of achieving the Custom, Unbound, Grounded, and Bound states. The MLS is integrated with and invokable by the CR mechanism, just like other platform services such as the Resource Deployment Service. The MLS executes CRs of the form changeModelStateTo: “desiredState” to transition the Service Lifecycle Model to the desired state. When a Change Request is issued to the MLS, it plans the required intermediate state transitions and actions by transforming the information in the MST to a valid sequence of CRs submitted to the CR Execution Engine. The scheme is shown in FIG. 12. In this example the MLS uses the MST to determine that to move the model from State 1 to State 3 requires the following sequence of CRs: A, B, C, D, and E. The MLS submits instances of these CRs to the Change Request Engine for execution A′, B′, C′, D′, and E′. The representation of CR-related information in the various models can more complex than FIG. 12 might suggest. For example a CR can represent a structure of child CRs.

The model-driven nature of the service lifecycle is very powerful. The sequence of allowed state changes, and the required CRs and their parameters to transition between states, can be modified at run-time by the tools invoked by CRs. Thus the behaviour of the system can be changed in response to information collected while progressing through the lifecycle. For example, if APE is required then a CR can be issued to update the MST to include CRs that cause the appropriate services to execute. In this way service lifecycle management is customized for the type of service and service configuration required by a customer.

Change Request Framework

This section describes a Change Request (CR) framework that enables the planning, submission, and execution of CRs. CRs can cause updates to models and run-time and change management for service instances.

Change requests are declarative, they state what needs to be accomplished, but leave out the details of how the modifications should be carried out. CR state includes the following.
A requestID that identifies the task to execute, e.g., create, clone, migrate, and stop.
A requestVersion identifies the implementation variant.
The context describes the model entity against which the change request is submitted. The context can be the whole model, or particular entities within the model such as elements corresponding to software components or infrastructure nodes.
parameters: primitive types or reference to any model entities.
pre-conditions and post-conditions: logical conditions that must be true prior/after the execution of a CR along with an implementation that evaluates the conditions.
subtasks: contains optional refinements of the change request into finer grain steps which are also CRs. Steps can execute in sequence or in parallel as defined by an ordering field.
dependencies: an optional set of references to external CRs that must complete before the change request can be processed.

The lifecycle of a CR is described as follows. A submission tool creates a CR and links it to the model entity it will operate on. First, a static validation takes place. Since the model entity contains only the set of CRs it allows, the validity of the request can be verified prior to submission. Assuming that the CR is valid, its current state is persisted in the model and passed to a CRE that initiates processing.

The CRE is a core backend service that coordinates tools and causes the execution of CRs. Tools register with the CRE to specify the request and model entity types they can support. For example, a virtual machine management tool registers that it supports migrate CRs on model entities of type virtual machine. Given a request to execute, the CRE looks at its request ID and the model entity against which the request is submitted and finds the appropriate service. Each tool has a unique identifier: a URL.

Assuming a tool is found and once the matching is done, the CRE persists the tool identifier in the CR in order to keep track of the implementer.

The CRE invokes the tool and a second round of dynamic checking takes place where the tool itself evaluates the CR's pre-conditions. For example, a request to increase the memory of a virtual machine will be rejected if the specified amount exceeds the free capacity of the physical host. Assuming the CR's pre-conditions are all validated, the tool proceeds to execute its finer grain processing steps. Once the finer grain steps are completed the tool enters a finalization processing phase where post-conditions are evaluated and current state is persisted in the model. State information captures change history for a service instance and can be used to support charge back mechanisms.

Finer grain steps for a CR are represented as a directed graph of CRs where the children of a node are subtasks, i.e., refinements, of the root CR. The graph encodes how the subtasks are ordered, and their dependencies. Whether the requests are handled in sequence or in parallel is defined by an ordering attribute. As an example of how these are used, in the case of SAP, the installation of a database and an application server can take place in parallel. However, strict ordering must ensure that the database is started before the application server.

The execution of a CR by a tool takes place asynchronously with respect to the orchestration environment. Each tool is responsible for updating and persisting progress for the run-time state of the request in the model and, in the case of failure, for being able to roll-back its changes or initiate an interaction with a human operator. The change request framework is compatible with fully automated and partially automated management. Even though most tasks can be dealt with in automated fashion, some tasks may require human intervention. Operation prototypes for CRs enable the dynamic creation of human readable forms for CRs that permit humans to complete CRs when necessary.

CRs can be hand crafted by humans as part of the development of an Infrastructure Design Template Model. In particular, to implement each CR they specify the sequence of tools that will be run and the parameters that are passed to each tool. It would also be feasible to exploit information about pre and post-conditions to enable descriptive CR subtask planning. Technologies such as model-checking may be used to reason about a CR and automatically develop a plan for a CR that exploits other CRs as subtasks to implement it.

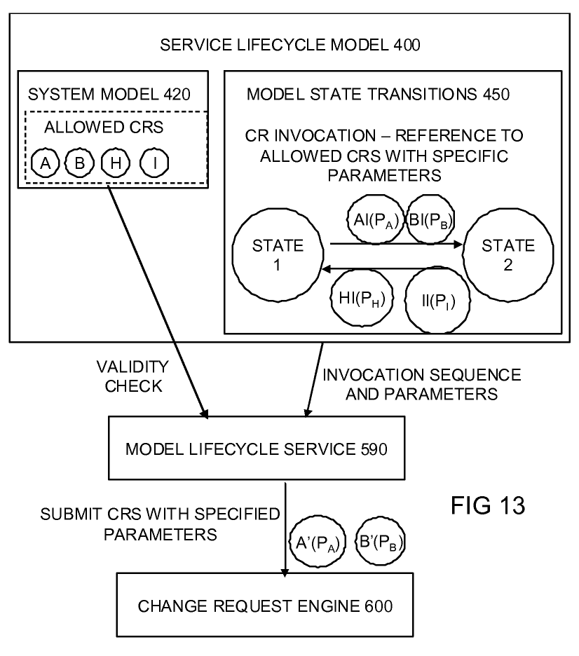

FIG. 13. Relationship of Allowed CRs, CR Invocation Specification and Submitted CRs.

FIG. 13 shows an example of relationships between CR-related entities in the System Model 420, MST 450, and CRs submitted to the CR Engine CRE 600. The System Model stores the set of allowed CRs that can be submitted to change the model, A, B, H, and I. The encoding of allowed CRs includes a specification of various constraints on the CR, such as valid ranges for parameters, pre- and post-conditions, and dependencies with other CRs. The MST actually encodes invocations of the allowed CRs to be made at run-time, Ai(pa), Bi(pb), etc; for each invocation a reference is made to the allowed CR together with the specific parameters to apply for the invocation. When a change of state is requested, the MST 590 can submit instances of the defined CR invocations, A′(pa), B′(pb), etc to be executed by the CR Engine. Before submitting a request, the MLS can first check the invocation parameters against the constraints defined for the allowed CRs.

Specification of the Content of the MST

Since the MST is a model, both the initial content and subsequent changes to the MST can be specified using declarative descriptions in a modelling language, which itself can be regarded as a model—the MST Specification Model. The MST Specification Model is specified in a human-readable, textual modelling language that can be rendered into the native representation of the MST in a model repository. An important characteristic of this language is that it can contain conditional statements that determine the output of this rendering process. The conditional statements can refer to other entities in the SLM, in particular the key-value pairs in the State Information which act as parameters to the rendering process. The combination of parameterisation and conditional statements are important for a flexible specification of the entities to be created or modified in the MST, and the values of the attributes of these entities. The selection of the initial MST Specification Model can be a key part of service instantiation, since it defines the initial content of the MST that sets in motion the subsequent lifecycle behaviour and the range of possible changes to that behaviour. It is a key part of the definition of the type or class of service. The rendering of the MST Specification Model to create or modify the underlying representation of the MST model in the model repository is performed by a rendering tool.

The rendering tool is exposed via a CR interface, which takes a reference to an MST Specification Model as a parameter. This CR can be referenced in the MST, allowing the MST to update itself. An embodiment can use SmartFrog as the language for MST Specification Model, reusing the declarative model description technologies used for the Infrastructure Design Template Model mentioned earlier. Other languages or structures can be used for the MST specification model. The Eclipse Modelling Framework (EMF) or other similar schemes can be used to represent the MST, SLM and other associated models, such as the STM and SM.

Behaviour Adaptation

The MST is stored in a model, which can itself be modified by a CR just like any other model associated with the SLM. For example, a CR may cause the MST itself to be updated to affect the operation of another CR used to modify the service model. This model-driven nature of the service lifecycle can be very powerful. The defined service lifecycle states, allowed state changes, and the required CRs to transition between states (including the parameters passed to the CR, and the order in which they are invoked) can all be modified at run-time as the service lifecycle progresses. Thus the behaviour of the system can be changed in response to information collected while progressing through the lifecycle. For example, if an Automated Performance Engineering (APE) analysis is required to fine tune the design of the service to better meet performance requirements, then a CR can be issued to update the MST to add a CR that will cause the APE service to execute. In this way service lifecycle management is customized for the type of service and service configuration required by a customer. When writing services at least two styles can be adopted for creating and updating the MST. Variations on these two styles are also possible. In the first style, the initial specification of the MST, created when the service is instantiated, need not specify the behaviour of the complete service lifecycle. The initial content of the MST may be very small, and only include the state transitions for the first part of the service lifecycle, perhaps to collect the requirements for the service. The MST would grow as the service lifecycle progresses—it is extended by the CRs invoked during the initial state transitions with additional or modified state and transitions that specify subsequent service-specific lifecycle behaviour targeted at the requirements. Another equally valid style is to fully populate the MST at service creation, and only allow very specific limited modifications to the MST to customize service lifecycle behaviour. Either style can be supported and selected.

Fuller automation can be achieved if the Service Model can be automatically updated for all or part of the lifecycle of a service, from collection of requirements, through design, to deployment. More reuse of code can result since patterns for managing service lifecycles as models can be defined, shared, and customized. This gives easier access to functionality, which is easier to maintain and check for correctness with less manual input. More flexibility can arise as the encoding of service behaviour can be automatically manipulated to allow a service to adapt to changing requirements and demands at run-time.

Infrastructure Design Template Models and the Template Instantiation Service

Designing and managing an IT system to support a service is a complex, error-prone activity that requires considerable human expertise, time, and expense. An important goal is to automate this process using best-in-class strategies distilled from human experts. An Infrastructure Design Template Model captures integrated best-practice design patterns for a service. It can be prepared by human experts and takes into account configuration options and non-functional requirements. Infrastructure Design Template Models are supplemental models.
The configuration of the monitoring and alarms for the hardware and software landscape.
The set of operations, represented as Change Requests (CR), which can be applied to extend or modify the system.
Configuration parameters and performance parameters.

An Infrastructure Design Template Model can also include embedded logic that matches configuration parameters to a particular design. Configuration parameters give the ability to encode related families of structural alternatives in a single Infrastructure Design Template Model thereby preventing an explosion in the number of instances of such models. An example extract is as follows:

```
aCompSystem IF (! ext_centralized) Comment... CENTRALIZED means
conditional instantiation of Monitored Computer System - instance only needed if not
centralised system
  THEN extends MonitoredComputerSystem {
    NICs extends { nic extends AI_NIC { subnet IF (ext_secure) THEN dbSubnet
    ELSE asSubnet FI; }} Comment... SECURE means connect NIC to DB or
    Application Server subnet and DUAL means need both DB and AS software
    otherwise just AS
    groundedExecutionServices IF (ext_dual)
      THEN extends { db extends DatabaseSoftware; ci extends
      ApplicationServerSoftware; }
      ELSE extends { ci extends ApplicationServerSoftware; }
      FI
    operations extends { updateMemory extends
    UpdateVirtualMachineMemoryCR; }
    } Comment instances of this template can request change in memory at run-time
  FI
```

The extract above represents an Infrastructure Design Template Model fragment, showing references to template parameters, conditional instantiation and operations. Boxed parts are comments. It is driven from three Boolean template parameters (ext_centralized, ext_secure, and ext_dual) that illustrates the conditional instantiation of a monitored computer system. The conditional instantiation of the computer system (aCompSystem) is controlled by the variable ext_centralized. Conditional reconfiguration of software running on it (groundedExecutionServices) is controlled by the variable (ext_dual), and the networking topology (NICs) is controlled by the variable ext_secure. Also note that the template fragment defines the set of allowed CRs as prototype operations. The allowed CRs may also depend on the configuration alternative.

The Infrastructure Design Template Service and the Template Instantiation Service will now be discussed. They support the creation of a System Template Model and System Model, respectively.

The Infrastructure Design Template Service loads the SmartFrog description of an Infrastructure Design Template Model. For each choice of configuration parameter values, the Infrastructure Design Template Service is able to render a corresponding System Template Model in the Eclipse Modeling Framework (EMF) modeling notation.

FIG. 15 UML diagram for an STM for a Decentralized SAP System.

FIG. 15 shows a Unified Modelling Language (UML) diagram for a System Template Model for a decentralized SAP system.

There are three levels shown by dotted line boxes. A virtual infrastructure level 730, an execution services level 720 and an execution components level 710. At the virtual infrastructure level the figure shows two types of computer system—a distinguished Application Server called the Central Instance (right), and additional Application Servers called Dialog Instances (left)—and how they are connected on a subnet. The two computer systems 790, 795, are coupled by a network 840 labelled “AI_network”, the right hand of the two systems corresponding to a master application server, and the left hand one corresponds to slave application servers. Hence it is decentralized. AI is an abbreviation of Adaptive Infrastructure. Another part not shown could be for example a computer system for a database coupled to the network. The type of each computer system is specified, in this case as a BL20/Xen. The slave application servers has an attribute “range=0 . . . n”. This means the template allows any number of these slave application servers.

For each type of computer system, the model specifies the type of software services running on it, referred to as Execution Services 720, the internal structure of that service in terms of software application components such as the type of worker threads, referred to as Execution Components 710, and the deployment settings for the software that reference deployment instructions and parameters. The template describes the minimum, maximum and default values for modeled entities that can be replicated. The ranges for the performance parameters of these entities are encircled. Either a human or a service such as APE should decide specific values for performance parameters.

The Template Instantiation Service transforms a System Template Model with specific values for performance parameters into a System Model. The System Model has a separate object for each replicated instance of an entity whereas the System Template Model has only one instance with a range. This supports further management for each replicated instance.

The example of infrastructure design template in FIG. 15 has predetermined parts of the computing infrastructure, predetermined relationships between the parts, and a limited number of options to be completed. In this case it is suitable for a decentralised SD business process, without security or availability features which could appear in other examples of such templates.

At the execution services level, the master application server is coupled to a box labelled AI_GroundedExecutionService: 785, indicating it can be used to run such a software element. It has an associated AIDeploymentSetting box 788 which contains configuration information and deployment information sufficient to allow the AI_GroundedExecutionService to be automatically installed, deployed and managed. The AI_GroundedExecutionService: 780 is shown as containing a component, at the execution components level, labelled AI_GroundedExecutionComponent 760, and having an associated AIDeploymentSetting box 775. This component is a dialog work process, for executing the application components of steps of the service, such as those steps described below with reference to FIG. 16 for the example of a business process. Another component can be for example an update process, responsible for committing work to persistent storage, or an enqueue process, for managing locks on a database. As shown, the range attribute is 2 . . . n for the update and the dialog work process, meaning multiple instances of these parts are allowed.

The slave application server has a GroundedExecutionService 780 having only one type of AI_GroundedExecutionComponent 750 for any number of dialog work processes. The slave application service is shown having a rangePolicy=2 . . . n, meaning it is allowed to have any number of instances. Again the service and the execution component each have an associated AIDeploymentSetting box, 787 and 770 respectively.

The master and slave application servers have an operating system shown as AI_disk: OSDisk 810, 830. The master application server can have local storage for use by the application components. For the network, each computer system has a network interface shown as AI_Nic1, 800, 820 coupled to the network shown by AI_Network:subnet1.

The deployment settings can specify key value pairs for use by a deployment service. They can point to a specific deployment engine to be used, and settings to indicate where to access deployment packages and configuration parameters. Examples can be configuration parameters, how much memory is needed, where to find a given database if needed and so on.

Optionally the template can have commands to be invoked by the tools, when generating the grounded model, or generating a changed grounded model to change an existing grounded model. Such commands can be arranged to limit the options available, and can use as inputs, parts of the template specifying some of the infrastructure design. They can also use parts of the unbound model as inputs.

FIG. 16 Example of Service

FIG. 16 shows an example of service design in the form of a custom model of the well-known Sales and Distribution (SD) Benchmark. This is software produced by the well known German company SAP. It is part of the SAP R/3 system, which is a collection of software that performs standard business functions for corporations, such as manufacturing, accounting, financial management, and human resources. The SAP R/3 system is a client server system able to run on virtually any hardware/software platform and able to use many different database management systems. For example it can use an IBM AS/400 server running operating system OS/400 using database system DB2; or a Sun Solaris (a dialect of Unix) using an Oracle database system; or an IBM PC running Windows NT using SQL Server.

SAP R/3 is designed to allow customers to choose their own set of business functions, and to customize to add new database entities or new functionality. The SD Benchmark simulates many concurrent users using the SD (Sales and Distribution) application to assess the performance capabilities of hardware. For each user the interaction consists of 16 separate steps (Dialog Steps) that are repeated over and over. The steps and their mapping to SAP transactions are shown in FIG. 16. A transaction here is an example of an Application Component. Each transaction is shown as a number of boxes in a row. A first box in each row represents a user invoking the transaction e.g. by typing /nva01 to start transaction VA01. As shown in FIG. 10, transaction VA01 in the top row involves the business process steps of invoking the create sales order transaction, then filling order details, then saving the sold-to party, and completing with the “back” function F3 which saves the data.

A next transaction VL01N is shown in the second row, and involves steps as follows to create an outbound delivery. The transaction is invoked,, shipping information is filled in, and saved. A next transaction VA03 is shown in the third row for displaying a customer sales order. This involves invoking the transaction, and filling subsequent documents. A fourth transaction is VL02N in the fourth row, for changing an outbound delivery. After invoking this transaction, the next box shows saving the outbound delivery. A next transaction shown in the fifth row is VA05, for listing sales orders. After invoking this transaction, the next box shows prompting the user to fill in dates and then a third box shows listing sales orders for the given dates. Finally, in a sixth row, the transaction VFO1 is for creating a billing document, and shows filling a form and saving the filled form.

Above has been described examples of how to transition a Service Lifecycle Model from the general state through to the deployed state. It assumes customers are aware of their functional and non-functional requirements and automatically chooses an infrastructure design based on these requirements. The design is then transitioned into an on-line system for load testing or use by users.

A model-driven approach as described can be applied for packaging high value enterprise software for use as a service, for managing the service lifecycle of service instances, and for interacting with shared virtualized resource pools. The framework can target the hosting of very large numbers of service instances that may operate in resource pools supported by the cloud computing paradigm. It can support the customization of service instances by customers who do not need to have infrastructure design skills. Finally, it can address non-functional requirement issues such as availability, security, and performance that are important for high value customizable service instances.

Gathering information needed for the models employed can be part of the process. The configuration of a service instance can determine the tools used to support its service lifecycle management. Supplemental models can capture service specific information. As a result, the approach can be applied to many different kinds of services. In some embodiments model information is re-used and shared by a variety of tools that support lifecycle management. Tools can be used in combination to create powerful model transformations and state transitions.

The virtual machines and software components can be implemented using any conventional programming language, including languages such as Java, C, and compiled following established practice. The servers and network elements of the shared infrastructure can be implemented using conventional hardware with conventional processors. The processing elements need not be identical, but should be able to communicate with each other, e.g. by exchange of IP messages.

Example Schema of some Common Modelled Entities

Schema 1 contained in appendix I below, shows a SmartFrog representation of a possible schema for some of the common modelled entities that can be created in a System Model. It is to be understood that other schemas are possible. This example SmartFrog schema would be loaded by an Infrastructure Design Template Model (IDTM) used to describe a Template. The described entities could either be used directly or could be subclassed to refine the schema with information appropriate for the specific system described by the IDTM.

This is not intended to show the schema for all possible entities modelled by a template. Instead it shows a subset to illustrate the principles such that those skilled in the art could extend the schema to model additional entities. The schema allows a template to be created that describes entities for virtual infrastructure, network subnets, software, specification of required monitoring, logical conditions to generate events from monitored data, allowed operations on modelled entities, and specification of policies to adapt the system in response to monitored data, events, and conditions.

The schema will now be described in more detail.

Almost all modelled entities are derived from AI_Object (line 1). This entity defines an attribute emfClass used to specify a mapping from the SmartFrog representation of a modelled entity to corresponding class in a different modelling technology used to persist the generated models in a Model Repository. In this case emfClass is used to refer to classes defined in the Eclipse Modelling Framework (EMF), but other modelling technologies could be used.

AI_Entity (line 5) models additional important concepts. allowedCRs is a list of the Allowed Operations supported by a modelled entity, implemented by a set of AI_ChangeRequest instances. policies is used to optionally specify one or more Adaptation Policy Specifications that may be applicable to the specific referencing AI_Entity instance, or may be applicable to other AI_Entity instances if the referencing instance is instantiated into the model. policies is shown in the schema represented as a string. A number of possibilities exist for how to specific Adaptation Policy Specifications using the policies attribute such as, but not limited to, specifying zero of more supplemental files containing Adaptation Policy Specifications, or specifying the Adaptation Policy Specifications directly in the string.

AI_EntityWithRange (line 15) extends AI Entity with notion of ranges of quantities of entities in the template that can be used to specify minimum, maximum, default, and actual number of instances of an entity to be created.

AI_ComputerSystem (line 67) is used to represent a virtual machine. It specifies the required characteristics such as memory, OS, and architecture. It also describes the required connectivity such as the set of volumes that need to be mounted, and the NICs to be configured. monitoring specifies the required monitoring to be set up for the virtual machine, shown as a list of AI Monitoring instances. groundedExecutionServices specifies the set of software services to be deployed on the virtual machine, shown as a list of AI_GroundedExecutionService instances.

AI_GroundedExecutionService (line 84) represents a software service to be deployed. It extends AI_GroundedComponent (not shown) that has a reference to AI_DeploymentSettings, to store configuration settings used by a Software Deployment Service to install, configure, and manage the software. As with AI_ComputerSystem, AI_GroundedExecutionService has a monitoring list to specify the required monitoring to be set up for the software.

AI_Monitoring (line 53) represents a required source of monitoring data, interpreted by a Monitoring Management system to deploy monitoring probes and configure listeners to generate events if one or more logical conditions on the monitored data streams are met. key contains a specification of properties to be monitored. A variety of identification mechanisms may be used. Examples include, but are not limited to, simple logical identifiers (such as PERCENTAGE_USER CPU) that are understood by the Monitoring Management system, or a URL to a source of more complex monitoring specifications encoded in XML, comma-separated lists, or Groovy for example. value optionally contains a specification of logical conditions on the specified monitored data streams that would cause listeners to be created by the Monitoring Management system to generate events if the logical conditions are met. The logical conditions may thus be used to specify concepts such as thresholds, based on instantaneous or historical analysis of the specified monitored data streams. Both the monitored data stream and any events generated from it can be referenced by Adaptation Policy behaviour that may have been loaded to listen and adapt the system appropriately.

AI_ChangeRequest (line 37) represents the set of allowed operations for a modelled entity. requestId is used to store an identifier of the operation. A tool that will carry out the operation registers itself with the Change Request Engine against a specific requestId. subtasks can refer to other child operations that an allowed operation may make use of, and allows construction of compound operations. ordering specifies ordering constraints such as whether child operations can occur in parallel or must be performed sequentially. inputs specifies the set of parameter inputs, each described using an instance of CRParameter, that can be passed to the operation. dependencies optionally specifies any other operations that this operation depends on and must be carried out first. preconditions specifies logical conditions that may depend on the state and attributes of modelled entities, to be interpreted by the Change Request Engine at run-time, that must be satisfied for the operation to be allowed.

CRParameter (line 23) represents a parameter to be passed to an operation. parameterID is a logical identifier of the parameter. type specifies the type of the value of a parameter, such as String, Integer, or Float. immutable is a Boolean indicating whether the parameter can be changed from its default, and may be interpreted by a User Interface component that allows operations to be submitted by a human user, in order to disable modification of the parameter. valid is a logical condition to be interpreted by the Change Request Engine to determine whether the supplied value of a parameter is valid. Such logical conditions may refer only to the specific parameter value, or may refer to combinations of parameters passed to the operation.

CRSimpleParameter (line32) represents one specific kind of parameter value for storing values that can be represented as Strings. Note that many kinds of value can be transformed into a String representation.

AI_Template (line 92) represents the top-level modelled entity of a template that describes a system design. computerSystems is the set of computer systems (AI_ComputerSystem instances) in the design. subnets is the set of network subnet domains (AI_Subnet instances) in the design.

Example Infrastructure Design Template Model for Simple Adaptive System

Template fragment 1 contained in appendix II below shows a fragment of an example Infrastructure Design Template Model describing a design for a simple adaptive system. The IDTM is described using the SmartFrog modelling language, and would load and extend the above described schema 1.

For space reasons, a complete description of all of the hardware and software entities of a real-world design are not shown; the example only illustrates the principles. The IDTM is driven from three Boolean template parameters (ext_centralized, ext_secure, and ext_dual) that may be derived from collected requirements for a service. These parameters are used to illustrate the conditional instantiation of entities, and conditional setting of modelled attributes in order to create a system design in which both the entities to be deployed and the policies to adapt those entities are represented in a consistent model that is created to meet the specified requirements according to the intent of the template author. The conditional instantiation of the computer system (aCompSystem) is controlled by the variable ext_centralized. Conditional reconfiguration of software running on it (groundedExecutionServices) is controlled by the variable (ext_dual), and the networking topology (connection of NICs to subnets) is controlled by the variable ext_secure. Also note that the template fragment defines the set of allowed operations, the required monitoring probes, conditional events on monitored data, and reference to the required Adaptation Policy that specifies adaptation behaviour; and that each of these may also depend on the configuration alternatives.

The example template fragment shows the definition of two allowed operations, UpdateVirtualMachineMemory (line 2) and UpdateVirtualMachineCPU (line 14), that respectively change the memory of a virtual machine to a specific value measured in megabytes, and increase by a specified percentage the amount CPU resource of the underlying physical machine allocated to a virtual machine. The valid statement shown in line 22 illustrates a logical condition stored in the model to check that the percentage parameter is valid.

NFSServer (line 27), DatabaseSoftware (line 33), and ApplicationServerSoftware (line 39) respresent the software to be allocated to virtual machines and deployed. SimpleSystemTemplate (line 45) represents the template itself and is a subclass of AI_Template. It defines two subnets, asSubnet and dbSubnet. At least one computer system is created, nfsCS (line 51), that hosts the NFS Server. A second computer system aCompSystem (line 55) is conditionally instantiated if the ext_centralized template parameter is false. The monitoring probes to be deployed for the computer system are specified in the monitoring set. cpu (line 69) specifies that a probe for the CPU used by the computer system should be set up—key (line 70) specifies that the probe should monitor total CPU utilisation, and value (line 71) specifies logical conditions for an event to be raised if the monitored values exceed greater than 50 percent utilisation. These conditions are only illustrative of one possible specification syntax. Similar monitoring specifications are also specified for memory utilisation of the computer system—memory (line 73). operations (line 78) specifies the set of allowed operations that may be applied to the computer system. The specification of the updateMemory operation illustrates the use of conditional logic to modify the default values passed to the operation. The same mechanism could equally have been used to control instantiation of the operation into the model, or any other of the properties of UpdateVirtualMachineMemory. policies references the set of adaptation policy behaviours to be loaded by the Adaptation Policy Manager; in this example, a named file (aCompSystem.policy) is specified containing the policy specifications. The example unconditionally specifies the aCompSystem.policy file, but the template parameters could have been used to specify an alternative file or more than one file for example.

Example Adaptation Policy Specification Referenced by the IDTM.

Adaptation Policy Specification I shown below is an example of a policy suitable for use with the IDTM fragment I described above. The policy that might be contained in the file referenced in line 84 by the IDTM fragment 1. Policies are loaded by an Adaptation Policy Engine. The Adaptation Policy Engine interprets the specification, sets up the required condition triggers, and performs the corresponding adaptation actions if a trigger is satisfied.

Adaptation Policy Specification 1:

1 policy (
2 name: “memoryPolicy”,
3 condition: {
4 vm(“aCompSystem”).memory.event ||
5 vm(“aCompSystem”).memory.avg(2).gt(0.7) },
6 action: {
7 vm(“aCompSystem”).updateMemory( )
8 vm(“aCompSystem”).updateCPU(10)
9 }
10 )

A policy specification file may contain many such policy specifications, but this example shows just one (line 1). Each adaptationpolicy has a name, here “memoryPolicy”.

condition is a specification of the logical conditions under which the specified action is to be carried out. Such conditions may reference the events specified in the monitoring probe specifications described earlier in relation to template fragment 1; for example the first part of the condition (line 4) refers to the memory event defined in line 75 of template fragment 1 for the virtual machine called “aCompSystem”. The second part of the conditional (line 5) is interpreted by the Adaptation Policy Engine as a direct reference to a historical analysis of the monitored data coming directly from the monitoring probe; in this case that average value of this data over the last 2 minutes is greater than 70 percent. The example shows one possible syntax to specify logical conditions on monitored data and events; other syntax and mechanisms are also possible.

action specifies the adaptation behaviour to be carried out is the condition is met. The action shown in the policy specification illustrates the use of the allowed operations defined in template fragment I to update the memory to the default value defined in the template, and increase the CPU allocated to the virtual machine by 10 percent. Note that the default value for the new value of the memory was conditionally defined in the template by the requirements.

Other variations can be conceived within the scope of the claims.

APPENDIX I
Schema 1:

11 AI_Object extends {
12 emfClass “AI_Object”;
13 }
14
15 AI_Entity extends AI_Object{
16 emfClass “AI_Entity”;
17 caption ; //of type java.lang.String
18 alias ; //of type java.lang.String
19 smState ; //of type java.lang.String
20 allowedCRs; // 1 to many AI_ChangeRequest
21 infos; // 1 to many Info
22 policies; //of type java.lang.String
23 }
24
25 AI_EntityWithRange extends AI_Entity{
26 emfClass “AI_EntityWithRange”;

| | |
|---|---|
| 27 minInstances 1; | //of type int |
| 28 maxInstances 1; | //of type int |

29 recommendedInstances 1; //of type int

| | |
|---|---|
| 30 actualInstances 1; | //of type int |

31 }
32
33 CRParameter extends AI_Object{
34 emfClass “CRParameter”;

| | |
|---|---|
| 35 parameterID ; | //of type java.lang.String |
| 36 description ; | //of type java.lang.String |
| 37 type “String”; | //of type java.lang.String |

38 immutable false; //of type boolean
39 valid ; //of type java.lang.String
40 }
41
42 CRSimpleParameter extends CRParameter{
43 emfClass “CRSimpleParameter”;
44 value ; //of type java.lang.String
45 }
46
47 AI_ChangeRequest extends AI_Object {
48 emfClass “AI_ChangeRequest”;

| | |
|---|---|
| 49 requestID ; | //of type java.lang.String |
| 50 description ; | //of type java.lang.String |

51 ordering “sequence”;
//of type com.hp.ait.models.common.CROrdering

| | |
|---|---|
| 52 implementerID ; | //of type java.lang.String |
| 53 statusMessage ; | //of type java.lang.String |

| | |
|---|---|
| 54 plannerID ; | //of type java.lang.String |

55 inputs; // 1 to many CRParameter
56 service; // 1 to 1 AI_Service (reference)
57 subtasks; // 1 to many AI_ChangeRequest
58 dependencies; // 1 to many AI_ChangeRequest (reference)
59 outputs; // 1 to many CRParameter
60 preconditions; // of type java.lang.String
61 }
62
63 AI_Monitoring extends AI_Entity {
64 emfClass “AI_Monitoring”;
65 key ; //of type java.lang.String
66 value ; //of type java.lang.String
67 }
68
69 AI_NIC extends AI_EntityWithRange{
70 emfClass “AI_NIC”;

| | |
|---|---|
| 71 MACAddress ; | //of type java.lang.String |
| 72 netIORequirements ; | //of type java.lang.String |

73 physicalNIC; // 1 to 1 AI_PhysicalNIC (reference).
74 subnet; // 1 to 1 AI_Subnet (reference)
75 }
76
77 AI_ComputerSystem extends AI_EntityWithRange{
78 emfClass “AI_ComputerSystem”;

| | |
|---|---|
| 79 memory 0; | //of type int |
| 80 hostname ; | //of type java.lang.String |

81 os ; //of type java.lang.String

| | |
|---|---|
| 82 provider ; | //of type java.lang.String |
| 83 state “OFF”; | //of type com.hp.ait.models.ic.AI_Computer- |
| | SystemState |
| 84 cpus “1”; | //of type java.lang.String |

```
85 hwArchitecture “x86”; //of type java.lang.String
86 physicalComputerSystem; // 1 to 1 AI_PhysicalComputerSystem
      (reference).
87 volumes; // 1 to many AI_Volume
88 NICs; // 1 to many AI_NIC
89 monitoring; // 1 to many AI_Monitoring
90 groundedExecutionServices;
      // 1 to many AI_GroundedExecutionService.
91 storageRequirements; // 1 to many AI_StorageRequirements
92 }
93
94 AI_GroundedExecutionService extends AI_GroundedComponent {
95 emfClass “AI_GroundedExecutionService”;
96 monitoring; // 1 to many AI_Monitoring
97 computerSystem; // 1 to 1 AI_ComputerSystem (reference).
98 groundedExecutionComponents; // 1 to many
  AI_GroundedExecutionComponent.
99 groundedApplicationModules;
      // 1 to many AI_GroundedApplicationModule.
100 }
101
102 AI_Template extends AI_Entity{
103 emfClass “ AI_Template”;
104 computerSystems; // 1 to many AI_ComputerSystem
        (containment)
105 subnets; // 1 to many AI_Subnet (containment)
106 }
```

APPENDIX II
Template fragment 1:

```
1
2 UpdateVirtualMachineMemory extends AI_ChangeRequest {
3 e_default “1000”; // Size parameter with default
4 requestID “UpdateVirtualMachineMemory”;
5 inputs extends {
6 p1 extends CRSimpleParameter {
7 parameterID “Size”;
8 value e_default;
9 type “Integer”;
10 }
11 }
12}
13
14UpdateVirtualMachineCPU extends AI_ChangeRequest {
15 e_value “5”; // Percentage parameter with default
16 requestID “UpdateVirtualMachineCPU”;
17 inputs extends {
18 p1 extends CRSimpleParameter {
19 parameterID “Percentage
20 value e_value;
21 type “Integer”;
22 valid “p1 < 100 && p1 > 0”
23 }
24 }
25}
26
27NFSServer extends AI_GroundedExecutionService {
28 type “NFS”;
29 alias “nfs”;
30 version “5.0”;
31}
32
33DatabaseSoftware extends AI_GroundedExecutionService {
34 type “Database”;
35 alias “db”;
36 version “1.0”;
37}
38
39ApplicationServerSoftware extends
  AI_GroundedExecutionService {
40 type “ApplicationServer”;
41 alias “as”;
42 version “1.6”;
43}
44
45SimpleSystemTemplate extends AI_Template {
46 subnets extends {
47 asSubnet extends AI_Subnet;
48 dbSubnet extends AI_Subnet;
49 }
50 computerSystems extends {
51 nfsCS extends AI_ComputerSystem {
52 NICs extends { nic extends AI_NIC{subnet DATA
  subnets:asSubnet;}}
53 groundedExecutionServices extends {nfs extends
  NFSServer;}
54 }
55 aCompSystem IF (!ext_centralized) THEN extends
  AI_ComputerSystem {
56 NICs extends {
57 nic extends AI_NIC {
58 subnet IF (ext_secure) THEN subnets:dbSubnet
59 ELSE subnets:asSubnet FI;
60 }
61 }
62 groundedExecutionServices IF (ext_dual)
63 THEN extends {
64 db extends DatabaseSoftware; ci extends
  ApplicationServerSoftware;
65 }
66 ELSE extends { ci extends
  ApplicationServerSoftware; }
67 FI
68 monitoring extends {
69 cpu extends AI_Monitoring {
70 key “cpu_total”; // CPU
71 value “gt 0.5”; // Condition
72 }
73 memory IF (ext_dual) THEN extends AI_Monitoring
  {
74 key “MEM_UTIL”;
75 value “gt 0.9”;
76 } FI
77 }
78 operations extends {
79 updateMemory extends UpdateVirtualMachineMemory
  {
80 e_default IF (ext_dual) THEN “2000” ELSE
  “3000” FI; };
81 }
82 updateCPU extends UpdateVirtualMachineCPU;
83 }
84 policies “aCompSystem.policy”;
85 FI
86 }
87}
88
89
```

1. A system for developing a computer implemented service, for deployment on computing infrastructure, the system having:
a model manager arranged to develop a model representing at least part of the service, and representing at least part of the computing infrastructure for the service, the model manager having:
a generating part arranged to generate variants of the model by automatically choosing values for a limited set of design variables, and
an evaluating part for evaluating the variants in operation,
the model manager being arranged to store in a model repository a current variant and at least some previous variants, and their evaluation results and derivation trails indicating how the variants are derived from each other,
the generating part being arranged to use the evaluation results and the derivation trails to generate a next current variant by making new choices of values, or by reverting to one of the previous variants.

2. The system of claim 1, the evaluation part being arranged to evaluate more than one of the variants in parallel.

3. The system of claim 1, the model manager being arranged to determine that one or more of the previous variants are unlikely to be useful and to delete them from the repository.

4. The system of claim 1, the evaluation comprising how well the model meets given requirements for the service.

5. The system of claim 1, the generating part being arranged to develop the model through a number of states of development, with variants being associated with a given one of the states and each of the states having a different set of design variables.

6. The system of claim 5, the model manager being arranged to store as part of the derivation trail other possible trails between any variants of any of the development states to enable reversion along the other possible trails.

7. The system of claim 1, the model manager being arranged to generate a variant in the form of a clone model of the service from the model, the clone model having its own clone model repository, and the model manager being arranged to develop the clone model separately from the development of its parent model.

8. The system of claim 7, the model manager being arranged to deploy the model and deploy one or more of the clone models to run their corresponding services in parallel.

9. The system of claim 8, the deployed model and the deployed clone model having monitors, and the model manager being arranged to develop the corresponding services in parallel according to an evaluation of the outputs of the monitors compared to given requirements for the service.

10. The system of claim 7, the clone model having a lifespan independent of that of the parent model.

11. The system of claim 1, the model manager being arranged to record a complete snapshot of at least one of the variants in the model repository, and the model manager being arranged to revert the model to a preceding variant according to the snapshot.

12. The system of claim 1, the model also representing a configuration of software components to implement the service, and allocations of infrastructure resources to run the software components.

13. The system of claim 1, the model also having an indication of allowed adaptation behaviour of the service.

14. The system of claim 1 having a deployment part arranged to deploy the service on shared infrastructure according to the model.

15. A method of providing a computer implemented service deployed on computing infrastructure, the method having the steps of developing a model representing at least part of the service, and representing at least part of the computing infrastructure for the service,
generating variants of the model by automatically choosing values for a limited set of design variables,
evaluating the variants in operation,
storing in a model repository a current variant and at least some previous variants,
and their evaluation results and derivation trails indicating how the variants are derived from previous variants,
using the evaluation results and the derivation trails to generate a next current variant by making new choices of values, or by reverting to one of the previous variants, and
deploying the service on the computing infrastructure according to the model to make it available to users.

16. The method of claim 15, the evaluating involving evaluating more than one of the variants in parallel.

17. The method of claim 15, having the step of developing the model through a number of states of development, with variants being associated with a given one of the states and each of the states having a different set of design variables.

18. The method of claim 15, having the steps of generating a variant in the form of a clone model of the service from the model, the clone model having its own clone model repository, and developing the clone model separately from the development of its parent model.

19. The method of claim 15 having the steps of providing a shared infrastructure for service providers to use for providing the computer implemented service, and enabling the service provider to develop their model of their service, and enabling the service provider to deploy their service on the shared infrastructure according to their model, to make the service available to users.

20. A computer program stored on a machine readable medium and arranged when executed, to carry out the steps of developing a model representing at least part of the service, and representing at least part of the computing infrastructure for the service,
generating variants of the model by automatically choosing values for a limited set of design variables,
evaluating the variants in operation,
storing in a model repository a current variant and at least some previous variants,
and their evaluation results and derivation trails indicating how the variants are derived from previous variants,
using the evaluation results and the derivation trails to generate a next current variant by making new choices of values, or by reverting to one of the previous variants, and
deploying the service on the computing infrastructure according to the model to make it available to users.
